(19) United States
(12) Patent Application Publication
(10) Pub. No.: US 2025/0197278 A1
(43) Pub. Date: Jun. 19, 2025

(54) PROCESS FOR DECARBONATION OF CARBONATED MATERIALS AND DEVICE THEREOF

(71) Applicant: FLSmidth A/S, Valby (DK)

(72) Inventors: Charles Robin, Faulx-les-Tombes (BE); Steven Bruce Guthrie, Malonne (BE); Pierre-Olivier Cambier, Hamme-Mille (BE); Johan Brandt, Nandrin (BE); Michael Prokesch, Coopersburg, PA (US); Thomas Freas, Orefield, PA (US); Timothy Kyle, Emmaus, PA (US)

(21) Appl. No.: 18/843,307

(22) PCT Filed: Mar. 2, 2023
(86) PCT No.: PCT/IB2023/051958

§ 371 Date: Sep. 2, 2024

Related U.S. Application Data
(60) Provisional application No. 63/375,451, filed on Sep. 13, 2022.
(60) Provisional application No. 63/315,692, filed on Mar. 2, 2022.

(30) Foreign Application Priority Data
Jan. 6, 2023 (DK) PA202300011
Jan. 6, 2023 (DK) PA202300012

(51) Int. Cl. C04B 2/10; F27B 15/14

(52) U.S. Cl. CPC C04B 2/106; F27B 15/14

(57) ABSTRACT

Various embodiments of a process and device for the decarbonation of limestone, dolomite or other carbonated materials are disclosed. The process and device may involve heating particles of carbonated materials (6) in a reactor (8) of a first circuit (2) to obtain decarbonated particles (16) comprising CaO and/or MgO; transferring the decarbonated particles (16) to one or more cooling sections (22, 22′) in which the conveyed decarbonated particles (16) release a portion of their thermal energy to second (14) and/or third gases (14′); and providing substantially pure oxygen to the reactor (8) at an oxygen entrance point which is preferably located below one or more fuel entrance points. Waste heat and/or vented gas may be recovered and re-used within the process by virtue of unique configurations of the device and provision of novel apparatus to the device.

### FIELD OF THE INVENTION

The invention relates to a process for decarbonation of limestone, dolomite or other carbonated materials and a device thereof.

### BACKGROUND AND PRIOR ART

Traditionally, the decarbonation of limestone or dolomite is performed through calcination in a kiln.

The traditional kilns reject significant amounts of CO₂ via the decarbonation of the minerals and the combustion of fuels. In the search for cleaner industrial plants and cost saving in emerging markets that penalize carbon emissions, efforts have been made to reduce the CO₂ footprint of kilns by introducing heat-regeneration measures. For instance, the air that is heated from product cooling is blown into the burning zone of the kiln and used for the combustion of the fuel. These improvements are required to achieve an efficiency with a specific heat input of <5.2 GJ/Tonne product. However, the CO₂ generated in the known kilns is still emitted to the atmosphere as it cannot be used or sequestered because it is too diluted in the flue gas.

To overcome these drawbacks, the skilled person has come along with the concept of a calciner as that disclosed in U.S. Pat. No. 4,707,350, where limestone particles are entrained/conveyed by CO₂ gas in a close-loop circuit. The carbonated particulates are first preheated before they are fed into a reactor where the decarbonation takes place under high temperatures. This known process overcomes most of the known drawbacks.

The decarbonation takes place in an atmosphere that is substantially free of nitrogen. The generated CO₂ can be used or sequestered. However, the extended residence time of decarbonated particles in a CO₂-rich atmosphere in a cooling zone positioned downstream from the decarbonation reactor causes recarbonizing of the product (i.e. lime).

Patent EP 2230223 B1 discloses a kiln comprising chambers, where a first chamber is dedicated to the decarbonation with an atmosphere that is free of nitrogen and a second chamber dedicated to the cooling of the decarbonated particles in an atmosphere that is free of CO₂ in order to limit the exposure of the product (i.e. lime) to CO₂. This process further teaches a solution to recover energy. This kiln (a.k.a. shaft kiln) presents a static technology, where pebbles are stacked in the chambers.

The kiln of EP 2230223 B1 is conceived to be operated with pebbles, for which it is difficult in practice to have a proper sealing device without introducing a complex locking mechanism between both chambers. Moreover, this kiln does not offer the possibility to optimise the operation of limestone quarries. Indeed, the fines that are generated during the crushing operations required to produce the pebbles are generally hardly used in such a kiln. Finally, the maximal throughput is typically around 500 to 600 t/day and this level is comparatively low to reach scale economies.

Patent application EP 3221264 A1 teaches a process for producing a highly calcined and uniformly calcined product in a flash calciner, where the decarbonation fine carbonated materials takes place in a few seconds. However, this publication fails to disclose any measure on how to operate two separated circuits, namely a calcination and a cooling circuit, in which circulate two different gases (one rich in CO₂ and the second free of CO₂) for conveying the particles of carbonated/decarbonated materials and fails to achieve the desired products of cooled pure CO₂ and decarbonated material from the carbonated material.

### Aims of the Invention

The invention aims to provide a solution to at least one drawback of the teaching provided by the prior art.

More specifically, the invention aims to provide a process and a device for simultaneously allowing a decarbonation with a high production throughput of a product while producing a CO₂ rich stream suitable for sequestration or use.

### SUMMARY OF THE INVENTION

For the above purpose, the invention is directed to a process for the decarbonation of limestone, dolomite or other carbonated materials, said process comprising the following steps: —heating particles of carbonated materials in a reactor of a first circuit up to a temperature range in which carbon dioxide of the carbonated materials is released to obtain decarbonated particles comprising CaO and/or MgO; —conveying particles of carbonated materials by a first entraining gas in the first circuit for preheating said carbonated materials; —transferring the decarbonated particles to a
cooling section of a second circuit in which the conveyed decarbonated particles release a portion of their thermal energy to a second entraining gas; —providing substantially pure oxygen to the reactor at an oxygen entrance point; the oxygen entrance point being located at a first location of the reactor; —providing fuel to the reactor at a plurality of fuel entrance points; each of the plurality of fuel entrance points being sequentially-spaced
from one another along the reactor and which are each located above the first location of the reactor; —independently adjusting and/or controlling the flow of fuel to each of the fuel entrance points; —combusting the fuel and oxygen within the reactor; and—by virtue of independently adjusting and/or controlling the flow of fuel to each of the fuel entrance points, controlling the temperature gradient of process gas throughout the reactor to
minimize high temperature zones and maintain a maximum temperature difference of the process gas distributed throughout the reactor to less than 200° C.

For the above purpose, the invention is also directed to a process for the decarbonation of limestone, dolomite or other carbonated materials, said process
comprising the following steps: —heating particles of carbonated materials in a reactor of a first circuit up to a temperature range in which carbon dioxide of the carbonated materials is released to obtain decarbonated particles comprising CaO and/or MgO; —conveying particles of carbonated materials by a first entraining gas in the first circuit for preheating said carbonated materials; —transferring the decarbonated particles to a
cooling section of a second circuit in which the conveyed decarbonated particles release a portion of their thermal energy to a second entraining gas; —separating the carbonated particles from a first entraining gas flow; —transferring the decarbonated particles to a cooling section of a second circuit comprising a second entraining gas in which the conveyed decarbonated particles release a portion of their thermal energy; —providing
substantially pure oxygen to the reactor; and—delivering at least some of the first entraining gas to the reactor in order to control and/or maintain a velocity of the substantially pure oxygen provided to the reactor within a predetermined velocity range.

For the above purpose, the invention is also directed to a process for the
decarbonation of limestone, dolomite or other carbonated materials, said process comprising the following steps: —heating particles of carbonated materials in a reactor of a first circuit up to a temperature range in which carbon dioxide of the carbonated materials is released to obtain decarbonated particles comprising CaO and/or MgO; —conveying particles of carbonated materials by a first entraining gas in the first circuit for
preheating said carbonated materials; —transferring the decarbonated particles from the first circuit to a cooling section of a second circuit in which a second entraining gas circulates; —cooling the decarbonated particles in the cooling section of the second circuit; —heating the second entraining gas by virtue of the decarbonated particles releasing a portion of their thermal energy to the second entraining gas; —separating the
decarbonated particles from a second entraining gas flow; —transferring the decarbonated particles from the second circuit to a cooling section of a third circuit in which a third entraining gas circulates; —cooling the decarbonated particles in the cooling section of the third circuit; —heating the third entraining gas by virtue of the decarbonated particles releasing a portion of their thermal energy to the third entraining gas; —
separating the decarbonated particles from a third entraining gas flow; —delivering at least some of the heated second entraining gas from the cooling section of the second circuit to the reactor, the second entraining gas being substantially pure oxygen; —delivering at least some of the heated third entraining gas from the cooling section of the third circuit to a heating section of the third circuit which is downstream of the cooling
section of the third circuit.

For the above purpose, the invention is also directed to a process for the decarbonation of limestone, dolomite or other carbonated materials, said process comprising the following steps: —heating particles of carbonated materials in a reactor of a first circuit up to a temperature range in which carbon dioxide of the carbonated materials is released to obtain decarbonated particles comprising CaO and/or MgO; —conveying particles of carbonated materials by a first entraining gas in the first circuit for preheating said carbonated materials; —transferring the decarbonated particles from the first circuit to a cooling section of a second circuit in which a second entraining gas circulates; —cooling the decarbonated particles in the cooling section of the second circuit; —heating the second entraining gas by virtue of the decarbonated particles releasing a portion of their thermal energy to the second entraining gas; —separating the decarbonated particles from a second entraining gas flow; —transferring the decarbonated particles from the second circuit to a cooling section of a third circuit in which a third entraining gas circulates; —cooling the decarbonated particles in the cooling section of the third circuit; —heating the third entraining gas by virtue of the decarbonated particles releasing a portion of their thermal energy to the third entraining gas; —separating the decarbonated particles from a third entraining gas flow; —delivering at least some of the heated second entraining gas from the cooling section of the second circuit to a heating section of the second circuit which is downstream of the cooling
section of the second circuit; —delivering at least some of the heated third entraining gas from the cooling section of the third circuit to the reactor, the third entraining gas being substantially pure oxygen.

According to specific embodiments of the invention, the process comprises one or more of the following technical features:
introducing substantially pure oxygen to a hot gas generator and directing heated substantially pure oxygen from the hot gas generator to the reactor at the oxygen entrance point;
using the hot gas generator as a “start-up heater” by temporarily introducing air to the hot gas generator and supplying heated air to the reactor from the hot gas generator during initial commissioning of the reactor;
separating the decarbonated particles from a second entraining gas flow in the cooling section;
said second entraining gas is comprised of substantially pure oxygen;
delivering at least some of the first entraining gas to the reactor in order to control and/or maintain a velocity of the substantially pure oxygen provided to the reactor within a predetermined velocity range;
said step of heating particles of carbonated materials in a reactor of a first circuit comprises introducing oxygen to a hot gas generator and directing heated
oxygen from the hot gas generator to the reactor;
using the hot gas generator as a “start-up heater” by introducing air to the hot gas generator and supplying heated air to the reactor from the hot gas generator during initial commissioning of the reactor;
introducing the particles of carbonated materials to a pre-heating section of the first circuit so that said particles are pre-heated by the first entraining gas by means of solid-gas heat exchange; said pre-heating section comprising at least a first solid/gas suspension heat exchanger, a filter, and at least one fan being located downstream of the at least a first solid/gas suspension heat exchanger and upstream and/or downstream of the filter; wherein the first solid/gas suspension heat exchanger comprises an inlet, an outlet, and a return;
reducing ambient air ingress into the pre-heating section of the first circuit by virtue of performing at least one of the following steps:
   maintaining a pressure drop between the inlet and the outlet which is equal to or below 1 kPa;
   maintaining an operating pressure in the pre-heating section which is above a pressure of the ambient air by increasing the pressure of the substantially pure oxygen entering the reactor;
   maintaining an operating pressure in the reactor section which is above a pressure of the ambient air by increasing the pressure of substantially pure oxygen entering the reactor;
   adjusting an RPM speed and/or louver/damper setting of the at least one of the fan to maintain a pressure in the filter that is above ambient pressure;
   adjusting an RPM speed and/or a louver/damper setting of the first fan, such that an operating pressure in the reactor is maintained between −1 kPa and +1 kPa.
producing the first entraining gas using the reactor;
conveying the decarbonated particles to a second reactor which is positioned downstream of the reactor and upstream of a cooling section of a second circuit;
conveying the decarbonated particles from the second reactor to the cooling section of the second circuit in which the conveyed decarbonated particles release a portion of their thermal energy;
maintaining a reductive environment within the second reactor by virtue of at least partially combusting carbon-containing fuel in the second reactor;
venting gas from the second reactor in one of the following manners:
   venting gas from the second reactor to a solid/gas separator located downstream of the second reactor and upstream of the cooling section of the second circuit;
   venting gas from the second reactor separately from the first entraining gas so as to avoid mixing between the first entraining gas (4) and the vented gas from the second reactor;
   venting gas from the second reactor to a solid/gas suspension exchanger provided within a heating section of the second circuit; the heating section being located downstream of the cooling section of the second circuit;
   venting gas from the second reactor and recycling at least some of the vented gas from the second reactor back to the second reactor;
conveying the decarbonated particles to a second reactor which is positioned downstream of the reactor and upstream of the cooling section of the second circuit;
conveying the decarbonated particles from the second reactor to the cooling section of the second circuit;
introducing a gas substantially free of CO₂, such as steam, to the second reactor;
venting gas from the second reactor to the reactor;
conveying particles of carbonated materials by a first entraining gas in a plurality of primary pre-heating sections of the first circuit for preheating said carbonated materials;
conveying the particles of carbonated materials to one or more reactors downstream of the plurality of primary pre-heating sections;
transferring the decarbonated particles from the one or more reactors to one or more cooling sections in the second circuit and/or to one or more second reactors located downstream of the one or more reactors;
introducing fuel and/or oxygen through a indirect heat exchanger within the cooling section of a second circuit;
cooling the decarbonated particles in the cooling section of the second circuit;
heating the fuel and/or oxygen using the indirect heat exchanger by virtue of:
   heat transfer between the decarbonated particles and the fuel and/or oxygen introduced to the indirect heat exchanger; and/or
   heat transfer between the second entraining gas and the fuel and/or oxygen introduced to the indirect heat exchanger; and
   delivering heated fuel and/or oxygen to the reactor from the indirect heat exchanger;
heating the second entraining gas by virtue of the conveyed decarbonated particles releasing a portion of their thermal energy;
supplementally heating the second entraining gas downstream of the cooling section of the second circuit;
conveying supplementally-heated second entraining gas to a heating section of the second circuit which is positioned downstream of said cooling section and upstream of the reactor in order to reduce oxygen consumption of the reactor;
heating particles of carbonated materials in the heating section of the second circuit using the supplementally-heated second entraining gas;
delivering heated particles of carbonated materials from the heating section of the second circuit to the reactor;
combusting fuel and oxygen within the reactor;
performing at least one of the following steps: I. adjusting, controlling, and/or changing a composition of the fuel during the step of combusting fuel and oxygen within the reactor; II. supplying a first type of fuel to a first one of a plurality of different fuel entrance points along the reactor and supplying a second type of fuel to a second one of said plurality of different fuel entrance points along the reactor; III. supplying a first type of fuel to the reactor, and subsequently supplying a second type of fuel to the reactor; the second type of fuel being different in composition than the first type of fuel;
the fuel is selected from one or more of the group consisting of: hydrogen gas; a solid fuel; and a fossil fuel.
combusting solid fuel and oxygen within the reactor to produce a first entraining gas; and
using either at least a portion of the first entraining gas or a gas substantially free of nitrogen, to pneumatically convey the solid fuel to: i.) the reactor and/or ii.) a hot gas generator configured to heat said substantially pure oxygen provided to the reactor;
the solid fuel comprises comprise particulate material including, but not limited to, plastics, coal, and/or biomass;
said first entraining gas comprises carbon dioxide released from the carbonated materials, and is substantially free of nitrogen;
cooling the particles of decarbonated materials with a second entraining gas in the cooling section of the second circuit; wherein the second entraining gas is substantially free of carbon dioxide;
said substantially pure oxygen is delivered to the reactor in combination with at least some of the second entraining gas entering the reactor;
said carbon-containing fuel comprises a fuel selected from the group consisting of: natural gas, propane, methane, or a solid fuel such as lignite or bituminous coal.

The invention also relates to a device for the decarbonation of limestone, dolomite or other carbonated materials comprising: —a first circuit in which a first entraining gas substantially free of nitrogen conveys particles of said carbonated mineral,
said first circuit comprising a reactor in which said particles are heated to a temperature range in which carbon dioxide is released to obtain decarbonated particles comprising CaO and/or MgO; —a second circuit in which a second entraining gas substantially free of carbon dioxide is circulated, the second circuit comprising a cooling section in which the decarbonated particles transferred from the first circuit, release a portion of their
thermal energy to the second entraining gas; —a source of substantially pure oxygen, the reactor being supplied with said source; —a source of fuel, the reactor being supplied with said source; wherein the reactor has an oxygen entrance point, being located at a first location of the reactor and a plurality of fuel entrance points; each of the plurality of fuel entrance points being sequentially-spaced from one another along the reactor and
which are each located above the first location of the reactor.

The invention also relates to a device for the decarbonation of limestone, dolomite or other carbonated materials comprising: —a first circuit in which a first entraining gas substantially free of nitrogen conveys particles of said carbonated mineral,
said first circuit comprising a reactor in which said particles are heated to a temperature range in which carbon dioxide is released to obtain decarbonated particles comprising CaO and/or MgO; —a second circuit in which a second entraining gas substantially free of carbon dioxide is circulated, the second circuit comprising a cooling section in which the decarbonated particles transferred from the first circuit, release a portion of their
thermal energy to the second entraining gas; —a third circuit in which a third entraining gas substantially free of carbon dioxide is circulated, the third circuit comprising a cooling section in which the decarbonated particles transferred from the second circuit, release a portion of their thermal energy to the third entraining gas.

According to specific embodiments of the invention, the device comprises one or more of the following features:
the third circuit comprises a heating section positioned downstream from the cooling section of the third circuit and the second entraining gas is substantially pure oxygen and the reactor comprises an oxygen entrance point arranged downstream from the second circuit;
the second circuit comprises a heating section positioned downstream from the cooling section of the second circuit, the third entraining gas is substantially pure oxygen and the reactor comprises an oxygen entrance point arranged downstream from the third circuit;
the cooling section and heating section each comprising at least one solid/gas suspension heat exchanger;
the first circuit comprises a pre-heating section, said pre-heating section comprising at least a first solid/gas suspension heat exchanger and/or a second solid/gas suspension exchanger, preferably said second solid/gas suspension exchanger being positioned downstream from said first solid/gas suspension heat exchanger;
the reactor comprises a fluidized bed reactor, an entraining bed reactor, a circulated fluidized bed or any combination thereof.

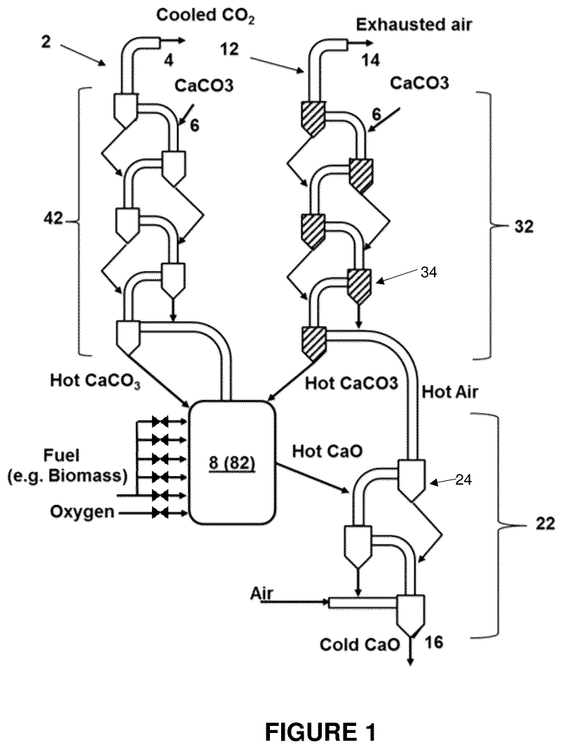

As suggested by FIG. 1, according to some embodiments, a device for
the decarbonation of limestone, dolomite or other carbonated materials may comprise means for supplying oxygen to a reactor (8). For example, an inlet for supplying oxygen to the reactor (8) may be positioned at a location adjacent the bottom of the reactor (8), and fuels may be fed to the reactor (8) above the oxygen entrance point. By feeding fuels to the reactor (8) above the oxygen feed point, high temperature zones may be
avoided and inlet velocities/velocities along the reactor (8) may be controlled.

For example, in some embodiments, a process of using the device and/or for decarbonizing limestone, dolomite or other carbonated materials may comprise one or more the following steps in any combination:
heating particles of carbonated materials (6) in a reactor (8) of a first circuit (2) up to a temperature range in which carbon dioxide of the carbonated materials is released to obtain decarbonated particles (16) comprising CaO and/or MgO;
conveying particles of carbonated materials (6) by a first entraining gas (4) in the first circuit (2) for preheating said carbonated materials (6), said entraining gas (4) comprising said carbon dioxide, said gas composition being substantially free of nitrogen;
providing oxygen to the reactor (8) at an oxygen entrance point at a first location of the reactor (8);
providing fuel to the reactor (8) at a plurality of fuel entrance points which are each spaced from one another, and which are each located above the first location of the reactor (8);
independently adjusting and/or controlling the flow of fuel to each of the fuel entrance points;
combusting the fuel and oxygen within the reactor (8);
by virtue of independently adjusting and/or controlling the flow of fuel to each of the fuel entrance points, controlling the temperature gradient of process gas throughout the reactor (8) to minimize high temperature zones and maintain a maximum temperature difference of the process gas distributed throughout the reactor (8) to less than 200° C.;
maintaining the process gas within the reactor (8) between approximately 1100 and 1300° C.
providing less fuel flow to one or more of the fuel entrance points which are more proximate to the first location, and providing more fuel flow to one or more of the fuel entrance points which are less proximate to the first location;
maintaining a maximum temperature difference of process gas within the reactor (8) to less than 200° C.;
keeping the process gas temperature distribution across the reactor (8) substantially uniform and/or homogeneous;
providing thermocouples at various thermocouple locations along the reactor (8);
measuring the temperature of the process gas in the reactor (8) at one or more of the thermocouple locations;
obtaining one or more temperature readings of the reactor (8) by virtue of measuring the temperature of the process gas in the reactor (8) at one or more of the thermocouple locations;
matching heat distribution with reaction heat load in the reactor (8);
providing less fuel to a lower region of the reactor (8), and providing more fuel to an upper region of the reactor.

In some embodiments, the step of independently adjusting and/or controlling the flow of fuel to each of the fuel entrance points may be performed as a function of the one or more temperature readings. In some embodiments, at least one of the thermocouple locations may be proximate to and/or downstream of at least one of the fuel entrance points.

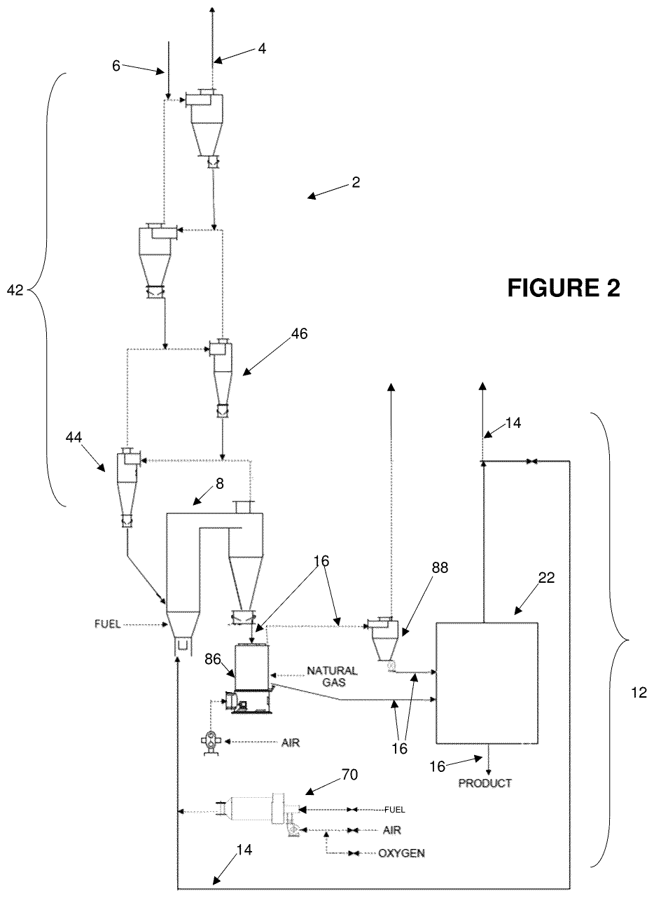

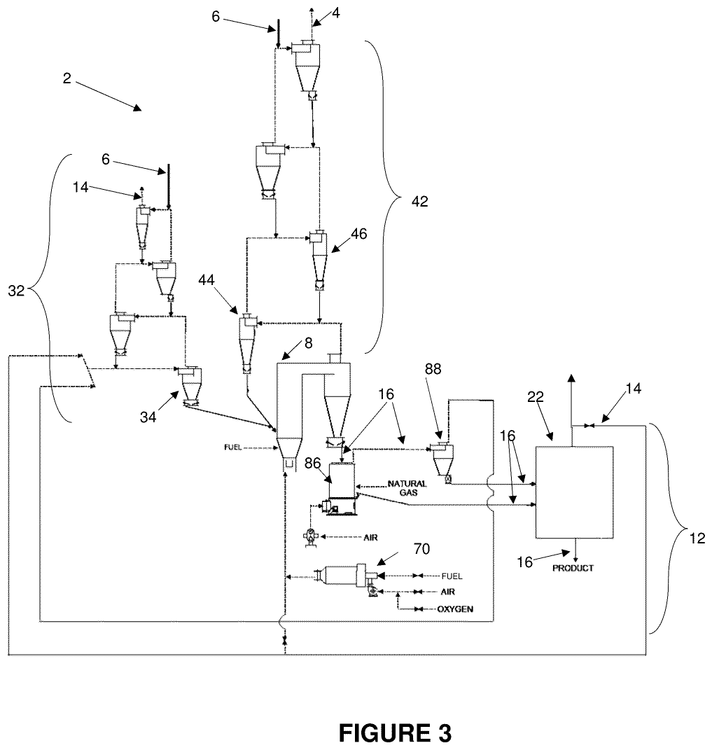

As suggested by FIGS. 2 and 3, according to some embodiments, a device for the decarbonation of limestone, dolomite or other carbonated materials may comprise a device that can switch to either oxyfuel, or air, or partial oxygen enrichment,
without limitation. Such embodiments may comprise an in-line connection between a cooler or cooling device, and the reactor (8).

For example, in some embodiments, a process of using the device and/or for decarbonizing limestone, dolomite or other carbonated materials may comprise one or more the following steps in any combination:
heating particles of carbonated materials (6) in a reactor (8) of a first circuit (2) up to a temperature range in which carbon dioxide of the carbonated materials is released to obtain decarbonated particles (16) comprising CaO and/or MgO;
conveying particles of carbonated materials (6) by a first entraining gas (4) in the first circuit (2) for preheating said carbonated materials (6), said entraining gas (4) comprising said carbon dioxide, said gas composition being substantially free of nitrogen;
transferring the decarbonated particles (16) to a cooling section (22) of a second circuit (12) comprising a second entraining gas (14) in which the conveyed decarbonated particles (16) release a portion of their thermal energy;
separating the decarbonated particles (16) from a second entraining gas (14) flow;
providing a second entraining gas (14) which is substantially free of carbon dioxide;
introducing oxygen to a hot gas generator (70) (e.g., an air heater) and directing heated oxygen from the hot gas generator (70) to the reactor (8);
directing some or all of the second entraining gas (14) flow to the reactor (8) with the heated oxygen from the hot gas generator (70);
commissioning the reactor (8); and using the hot gas generator (70) as a “start-up” air heater by introducing air to the reactor (9) and introducing heated air to the reactor (8) during commissioning of the reactor (8);
controlling a flow of air and/or oxygen to the hot gas generator (70);
controlling a flow of the second entraining gas (14) to the reactor (8);
controlling a flow of the heated oxygen to the reactor (8);
adjusting the flow of the second entraining gas (14) relative to the flow of the heated oxygen to the reactor (8), or vice-versa;
periodically delivering at least a portion the second entraining gas (14) to the reactor (8);
periodically stopping a flow of the second entraining gas (14) to the reactor (8);
commissioning the reactor (8) and delivering air to the hot gas generator (70) for commissioning and start-up of the reactor (8);
delivering oxygen to the hot gas generator (70);
heating oxygen with the hot gas generator (70);
delivering heated oxygen to the reactor (8) during normal operation of the reactor (8) such that the hot gas generator (70) functions as a main oxygen heater;
adjusting an air to oxygen flow ratio to the hot gas generator (70); wherein the hot gas generator (70) is configured with control valves for adjusting the flow of air and/or oxygen delivered thereto;
increasing the inlet velocity of oxygen delivered to the reactor (8) by heating oxygen with the hot gas generator (70) upstream of the reactor (8);
increasing the volume of oxygen delivered to the reactor (8) by heating oxygen with the air heater upstream of the reactor (8).

In some embodiments, the hot gas generator (70) may be configured to switch between modes of: receiving and heating air only, receiving and heating oxygen only, and receiving and heating a mixture of oxygen and air; and the process may comprise the step of switching between at least two of said aforementioned modes.

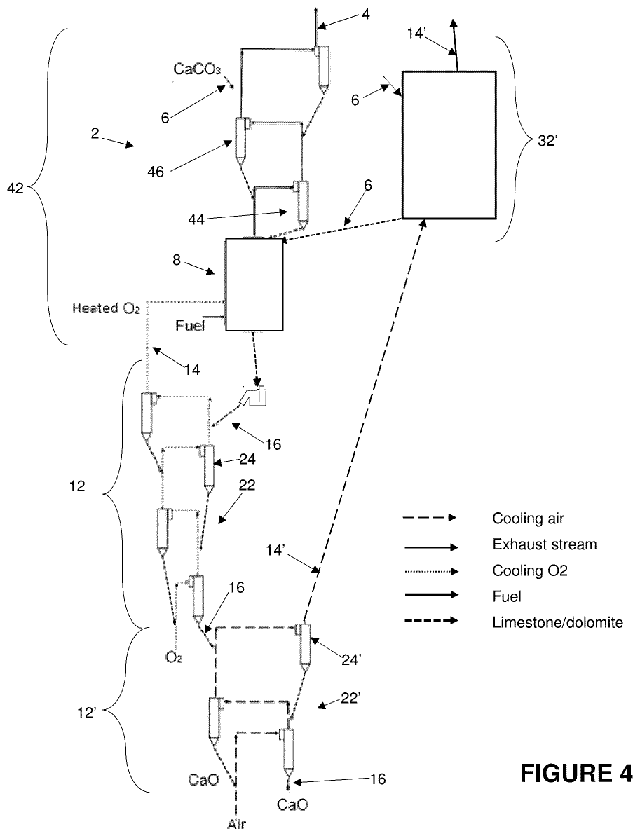

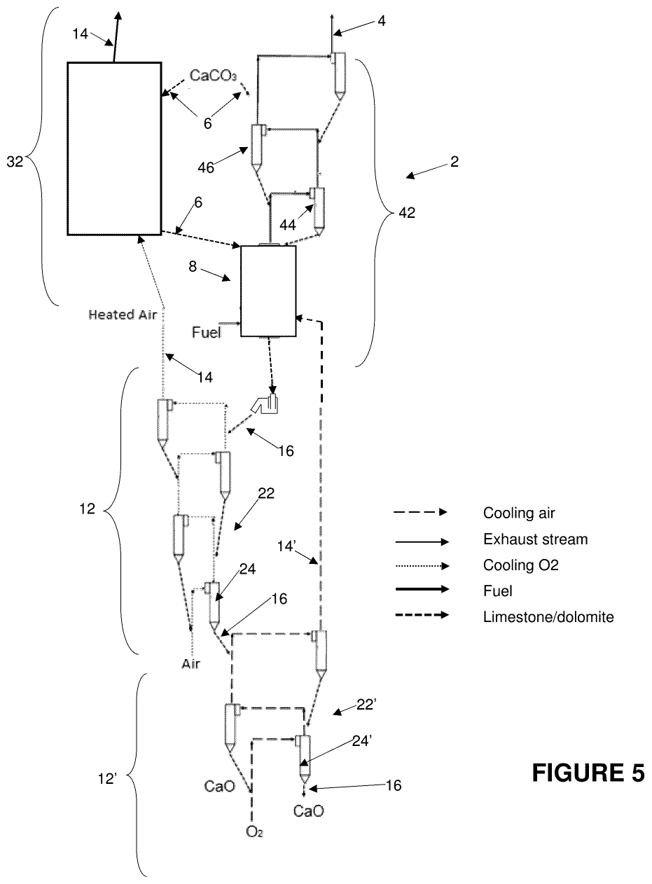

As suggested by FIGS. 4 and 5, according to some embodiments, a device for the decarbonation of limestone, dolomite or other carbonated materials may be configured for pure oxyfuel use. In such embodiments, oxygen may be used in a cooling cyclone tower or other portion of a cooling section (22, 22′) of a second circuit (12).

For example, in some embodiments, a process of using the device and/or for decarbonizing limestone, dolomite or other carbonated materials may comprise one or more the following steps in any combination:
heating particles of carbonated materials (6) in a reactor (8) of a first circuit (2) up to a temperature range in which carbon dioxide of the carbonated materials is released to obtain decarbonated particles (16) comprising CaO and/or MgO;
conveying particles of carbonated materials (6) by a first entraining gas (4) in the first circuit (2) for preheating said carbonated materials (6);
transferring the decarbonated particles (16) to a cooling section (22) of a second circuit (12) in which the conveyed decarbonated particles (16) release a portion of their thermal energy;
separating the decarbonated particles (16) from a second entraining gas (14) flow;
providing a second entraining gas (14) or a portion thereof, which is comprised essentially of substantially pure oxygen;
providing a cooler fan to a cooling section (22, 22′) of the second circuit (12) or a third circuit (12′);
introducing pure oxygen to the second entraining gas (14);
introducing pure oxygen to the second entraining gas (14) at an inlet of the cooler fan;
introducing pure oxygen to the second entraining gas (14) downstream of an outlet of the cooler fan;
introducing pure oxygen to the second entraining gas (14) in the cooling section (22) of the second circuit (12);
introducing a second entraining gas (14) to the cooling section (22), wherein said second entraining gas (14) is comprised of substantially pure oxygen;
heating the second entraining gas (14) by virtue of heat exchange between the decarbonated particles (16) and the second entraining gas (14) within the cooling section (22) to produce partially-cooled decarbonated particles (16) in the cooling section (22);
transferring heated second entraining gas (14) to the reactor (8) and combusting it within the reactor (8);
transferring partially-cooled decarbonated particles (16) to a cooling section (22′) within a third circuit (12′) (e.g., from the cooling section (22) of the second circuit (12));
introducing a third entraining gas (14′) to the second cooling section (22′), wherein said third entraining gas (14′) is substantially comprised of air;
heating the third entraining gas (14′) by virtue of heat exchange between the partially-cooled decarbonated particles (16) and the third entraining gas (14′) within the cooling section (22′) of the third circuit (12′) to produce cooled decarbonated particles (16);
conveying heated third entraining gas (14′) to a location upstream of an inlet to the reactor (8) in a heating section (32′) of the third circuit (12′); wherein the location upstream of an inlet to the reactor (8) may comprise an inlet to a first solid/gas suspension heat exchanger (34′) within the heating section (32′) of the third circuit (12′).

Moreover, according to some embodiments, the process may comprise any combination of the following steps:
introducing a second entraining gas (14) to a cooling section (22) of a second circuit (12), wherein said second entraining gas (14) is substantially comprised of air;
heating the second entraining gas (14) by virtue of heat exchange between the decarbonated particles (16) and the second entraining gas (14) within the cooling section (22) to produce partially-cooled decarbonated particles (16) in the cooling section (22);
transferring the partially-cooled decarbonated particles (16) to a cooling section (22′) within a third circuit (12′);
introducing a third entraining gas (14′) to the cooling section (22′) of the third circuit (12′), wherein said third entraining gas (14′) is substantially comprised of pure oxygen;
heating the third entraining gas (14′) by virtue of heat exchange between the partially-cooled decarbonated particles (16) and the third entraining gas (14′) within the cooling section (22′) of the third circuit (12′) to produce cooled decarbonated particles (16);
transferring heated third entraining gas (14′) to the reactor (8) and combusting it within the reactor (8);
transferring heated second entraining gas (14) to a location upstream of an inlet to the reactor (8) for pre-heating carbonated materials (6);
conveying heated second entraining gas (14) to a location upstream of an inlet to the reactor (8) in a heating section (32) of the second circuit (12); wherein the location upstream of an inlet to the reactor (8) may be an inlet to a first solid/gas suspension heat exchanger (34) within the heating section (32) of the second circuit (12);
conveying substantially pure oxygen to the reactor (8);
conveying fuel to the reactor (8);
combusting the fuel to the reactor (8) and the substantially pure oxygen to the reactor (8).

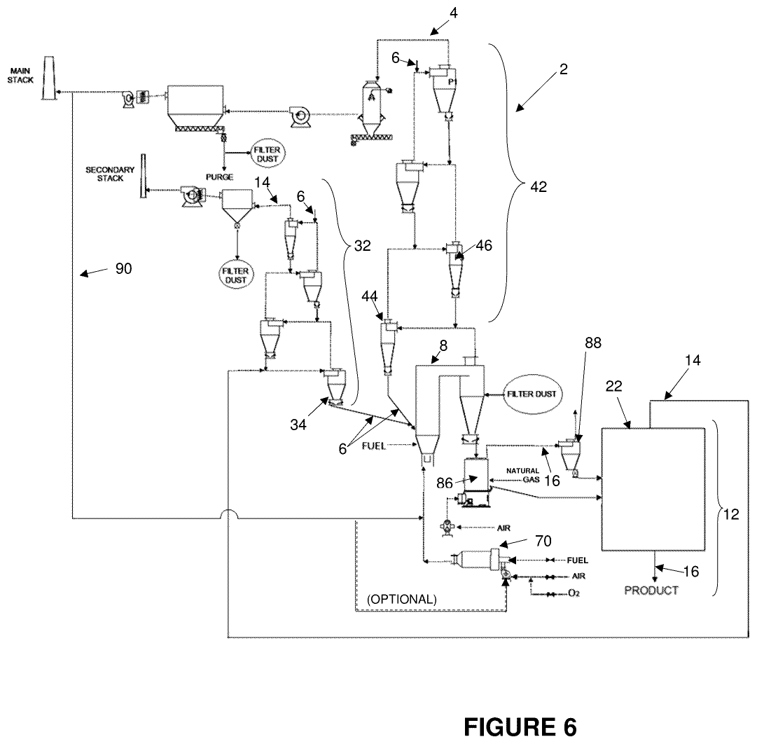

As suggested by FIG. 6, according to some embodiments, a device for the decarbonation of limestone, dolomite or other carbonated materials may be configured to maximize turn-down by including a flue gas recirculation.

For example, in some embodiments, a process of using the device and/or for decarbonizing limestone, dolomite or other carbonated materials may comprise one or more the following steps in any combination:
heating particles of carbonated materials (6) in a reactor (8) of a first circuit (2) up to a temperature range in which carbon dioxide of the carbonated materials is released to obtain decarbonated particles (16) comprising CaO and/or MgO;
conveying particles of carbonated materials (6) by a first entraining gas (4) in the first circuit (2) for preheating said carbonated materials (6), said entraining gas (4) comprising said carbon dioxide, said gas composition being substantially free of nitrogen;
separating the carbonated particles (6) from a first entraining gas (4) flow;
transferring the decarbonated particles (16) to a cooling section (22) of a second circuit (12) comprising a second entraining gas (14) in which the conveyed decarbonated particles (16) release a portion of their thermal energy;
providing pure oxygen to the reactor (8);
delivering at least some of the first entraining gas (4) to the reactor (8);
delivering at least some of the first entraining gas (4) to the reactor (8) from a location upstream of a main stack;
delivering at least some of the first entraining gas (4) to the reactor (8) from a location downstream of the reactor (8);
delivering at least some of the first entraining gas (4) to the reactor (8) from a location downstream of a pre-heating section (42) of the first circuit (2);
delivering at least some of the first entraining gas (4) to the reactor (8) from a location downstream of a solid/gas heat exchanger (44) in the pre-heating section (42) of the first circuit (2);
delivering at least some of the first entraining gas (4) to a hot gas generator (70) upstream of the reactor (8); the hot gas generator (70) being configured for heating air and/or oxygen and supplying heated air and/or heated oxygen to the reactor (8);
providing oxygen to the hot gas generator (70);
maintaining a ratio of oxygen provided to the hot gas generator (70): first entraining gas (4) which is sufficient for burning the first entraining gas (4) in the hot gas generator (70);
maintaining a ratio of oxygen provided to the hot gas generator (70): first entraining gas (4) which is sufficient for burning the first entraining gas (4) in the reactor (8).

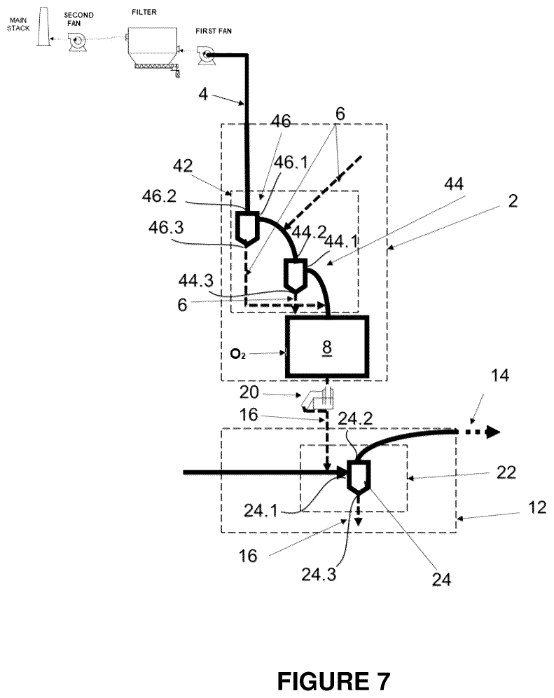

As suggested by FIG. 7, according to some embodiments, a device for the decarbonation of limestone, dolomite or other carbonated materials may comprise means to enhance air-tightness in a pre-heating section (42) for heating particles of carbonated materials (6) before they enter a reactor (8). One or more air-tight cyclones or locks may be provided to the pre-heating section (42). One or more fans (e.g., one upstream and one downstream of a filter) may be provided to the pre-heating section (42), in order to distribute pressure drop or provide a mitigation measure to avoid false air intake, without limitation. The pre-heating section (42) may be configured so as to control the pressure drop profile across the pre-heating section (42) by careful selection of solid/gas suspension heat exchangers (44, 46) (e.g., via the use of high-efficiency cyclones) and/or by employing one or more forced draft fans and controlling the same, without limitation.

For example, in some embodiments, a process of using the device and/or for decarbonizing limestone, dolomite or other carbonated materials may comprise one or more the following steps in any combination:
heating particles of carbonated materials (6) in a reactor (8) of a first circuit (2) up to a temperature range in which carbon dioxide of the carbonated materials is released to obtain decarbonated particles (16) comprising CaO and/or MgO;
conveying particles of carbonated materials (6) by a first entraining gas (4) in the first circuit (2) for preheating said carbonated materials (6), said first entraining gas
(4) comprising said carbon dioxide, said gas composition being substantially free of nitrogen;
introducing the particles of carbonated materials (6) to a pre-heating section (42) of the first circuit (2) so that said particles are pre-heated by the first entraining gas (4) by means of solid-gas heat exchange; said pre-heating section (42) comprising at least a first solid/gas suspension heat exchanger (44); wherein the first solid/gas suspension heat exchanger (44) comprises an inlet (44.1), an outlet (44.2), and a return (44.3);
reducing ambient air ingress into the pre-heating section (42) of the first circuit (2) by virtue of maintaining a pressure drop between the inlet (44.1) and the outlet (44.2) which is equal to or below 1 kPa;
maintaining the pressure drop between the between the inlet (44.1) and the outlet (44.2) of the first solid/gas suspension heat exchanger (44) to between approximately 0.5 kPa and 1.0 kPa;
reducing ambient air ingress into the pre-heating section (42) of the first circuit (2) by virtue of maintaining the pressure drop measured between the inlet (46.1) of the second solid/gas suspension heat exchanger (46) and the outlet (46.2) of the second solid/gas suspension heat exchanger (46) to equal or below 1 kPa;
maintaining the pressure drop between the between the inlet (46.1) and the outlet (46.2) of the second solid/gas suspension heat exchanger (46) to between approximately 0.5 kPa and 1.0 kPa;
separating the carbonated particles (6) from a first entraining gas (4) flow;
transferring the decarbonated particles (16) to a cooling section (22) of a second circuit (12) comprising a second entraining gas (14) in which the conveyed decarbonated particles (16) release a portion of their thermal energy;
separating the decarbonated particles (16) from a second entraining gas (14) flow;
reducing ambient air ingress into the pre-heating section (42) of the first circuit (2) by virtue of determining an acceptable range for an operating pressure in the reactor (8); periodically measuring a current operating pressure in the reactor (8); adjusting an RPM speed and/or a louver/damper setting of a first fan positioned downstream of the pre-heating section (42) of the first circuit (2) and upstream of a filter which is configured for receiving and filtering the first entraining gas (4), such that the current
operating pressure in the reactor (8) is maintained within the acceptable range;
maintaining the current operating pressure in the reactor (8) at or above a neutral pressure with respect to said ambient air;
providing a filter configured for receiving and filtering the first entraining gas (4) downstream of the pre-heating section (42) of the first circuit (2);
providing a first fan positioned downstream of the pre-heating section (42) and upstream of the filter;
providing a second fan positioned downstream of the filter;
reducing ambient air ingress into the filter by virtue of adjusting an RPM speed and/or louver/damper setting of at least one of the first and second fans;
adjusting an RPM speed and/or louver/damper setting of the first fan independently from a step of adjusting an RPM speed and/or louver/damper setting of the second fan;
maintaining the filter at or above a neutral pressure with respect to the ambient air by adjusting an RPM speed and/or louver/damper setting of the second fan;
reducing ambient air ingress into the pre-heating section (42) of the first circuit (2) by virtue of maintaining an operating pressure in the pre-heating section (42) which is above a pressure of the ambient air by increasing the pressure of oxygen entering the reactor (8);
increasing the pressure and/or velocity of oxygen entering the reactor (8) such that the pressure in the filter is equal to or above the pressure of the ambient air;
maintaining the pressure of oxygen entering the reactor (8) above the total pressure drop across the entire pre-heating section (42) of the first circuit (2);
discouraging dilution of the first entraining gas (4) with gases other than carbon dioxide by virtue of performing said steps of reducing ambient air ingress into the pre-heating section (42) of the first circuit (2) and/or reducing ambient air ingress into the filter.

In some embodiments, the first solid/gas suspension heat exchanger (44) comprises a high-efficiency cyclone separator which is configured to deliver high solid transfer efficiencies with low pressure drops between the inlet (44.1) and the outlet (44.2). In some embodiments, the pre-heating section (42) of the first circuit (2) further comprises a second solid/gas suspension heat exchanger (46) comprising an inlet (46.1), an outlet (46.2), and a return (46.3). In some embodiments, the second entraining gas (14) is substantially free of carbon dioxide. In some embodiments, the acceptable range for an operating pressure in the reactor (8) is between negative 0.5 kPa and positive 0.5 kPa.

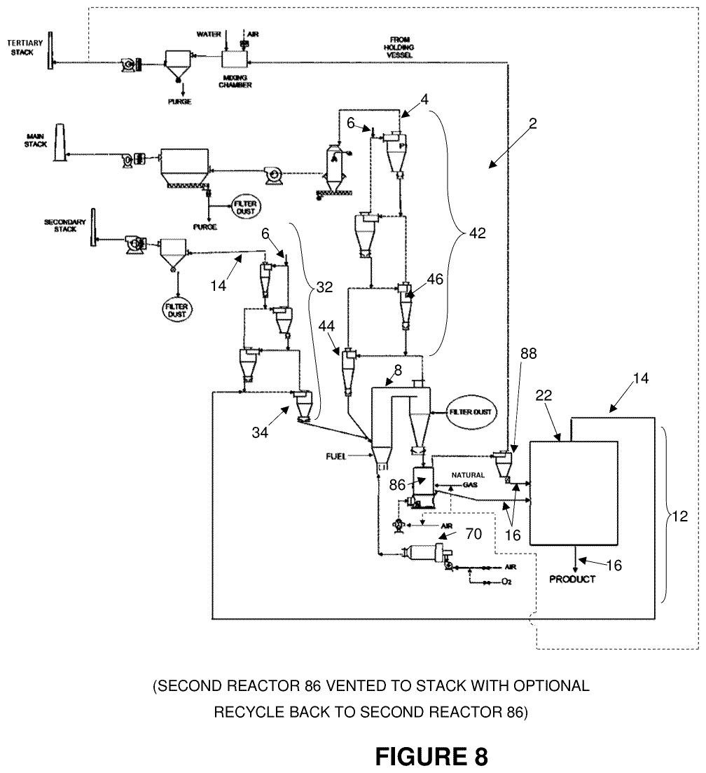

As suggested by FIGS. 8-11, according to some embodiments, a device for the decarbonation of limestone, dolomite or other carbonated materials may comprise means for providing a reductive atmosphere or reducing conditions in a second reactor (86). A gas within the second reactor (86) may be vented using a separate vent, or without using a separate vent. A gas within the second reactor (86) may also be vented to another portion of the device. For example, the second reactor (86) may be connected to another component in such a way that the device is configured to transfer some of the gas from the second reactor (86) to a pre-heating string (32, 32′) using hot air from a cooler or cooling string within a cooling section (22, 22′).

For example, in some embodiments, a process of using the device and/or for decarbonizing limestone, dolomite or other carbonated materials may comprise one or more the following steps in any combination:
heating particles of carbonated materials (6) in a reactor (8) of a first circuit (2) up to a temperature range in which carbon dioxide of the carbonated materials is released to obtain decarbonated particles (16) comprising CaO and/or MgO using a first entraining gas (4) produced by the reactor (8);
conveying the decarbonated particles (16) to at least one second reactor (86) which is positioned downstream of the reactor (8) and upstream of at least one cooling section (22) of a second circuit (12);
conveying the decarbonated particles (16) from the at least one second reactor (86) to the at least one cooling section (22) of the second circuit (12) in which the conveyed decarbonated particles (16) release a portion of their thermal energy;
maintaining a reductive environment within the at least one second reactor (86) by virtue of adding natural gas and/or air to the at least one second reactor (86);
venting gas from the at least one second reactor (86);
separating the vented gas from the at least one cooling section (22) of the second circuit (12);
venting the gas from the at least one second reactor (86) to a solid/gas separator which is located downstream of the at least one second reactor (86) and upstream of the at least one cooling section (22) of the second circuit (12);
venting the gas from the at least one second reactor (86) to a stack which is separate from a main stack;
venting the first entraining gas (4) through the main stack;
conveying the decarbonated particles (16) from the at least one second reactor (86) to a solid/gas separator which is positioned downstream of the at least one second reactor (86) and upstream of the cooling section (22) of the second circuit (12);
conveying the decarbonated particles (16) from the solid/gas separator to the at least one cooling section (22) of the second circuit (12);
venting the gas to a heat exchanger and/or a mixing chamber before it passes through a stack which is separate from a main stack which expels the first entraining gas (4);
recycling at least some of the vented gas from the at least one second reactor (86) back to the at least one second reactor (86) before it is vented to a secondary stack.

Moreover, in some embodiments, the first circuit (2) may comprise a first pre-heating section (42) and the second circuit (12) may comprise a heating section (32). In such embodiments, the process may comprise the step of conveying the vented gas from the at least one second reactor (86) to the heating section (32) of the second circuit (12) at a point upstream of the reactor (8).

The gas vented from the at least one second reactor (86) may be sent to a solid/gas suspension exchanger (34) in the heating section (32) of the second circuit (12). The gas vented from the at least one second reactor (86) may be different in composition than a first entraining gas (4) in the first pre-heating section (42) of the first circuit (2). The first entraining gas (4) in the first pre-heating section (42) of the first circuit (2) may comprise carbon dioxide. The carbon dioxide in the first entraining gas (4) may represent at least 85% by volume of the dry composition of the first entraining gas (4) exiting the reactor (8). At least a portion of a second entraining gas (14) in the heating section (32) of the second circuit (12) may comprise the gas vented from the at least one second reactor (86). The second entraining gas (14) may comprise a substantially lower carbon dioxide composition % by dry volume than the first entraining gas (4), without limitation.

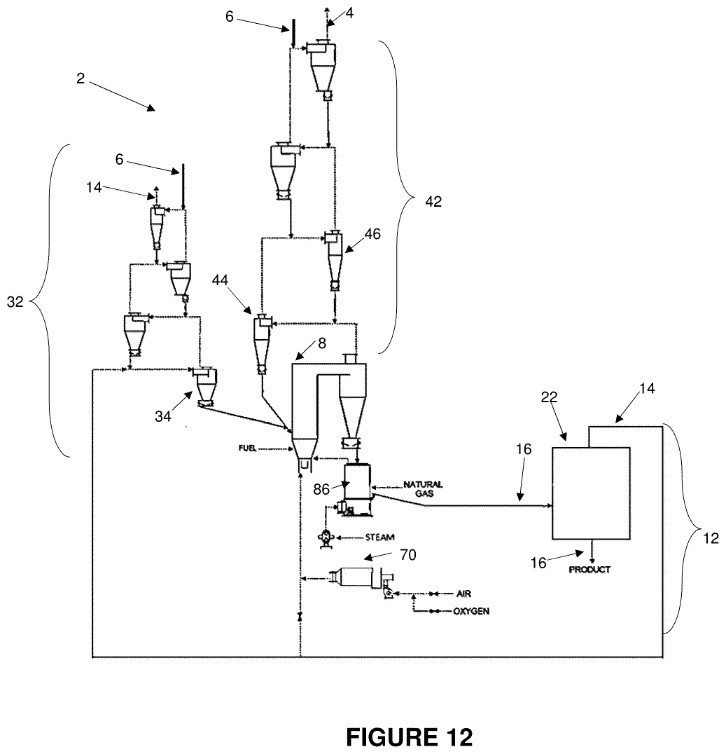

As suggested by FIG. 12, according to some embodiments, a device for the decarbonation of limestone, dolomite or other carbonated materials may comprise fluidization of contents of a second reactor (86) with a CO₂-free gas stream (e.g., steam).

For example, in some embodiments, a process of using the device and/or for decarbonizing limestone, dolomite or other carbonated materials may comprise one or more the following steps in any combination:
heating particles of carbonated materials (6) in a reactor (8) of a first circuit (2) up to a temperature range in which carbon dioxide of the carbonated materials is released to obtain decarbonated particles (16) comprising CaO and/or MgO;
conveying the decarbonated particles (16) to at least one second reactor (86) which is positioned downstream of the reactor (8) and upstream of at least one cooling section (22, 22′) (e.g., of a second (12) and/or third (12′) circuit);
conveying the decarbonated particles (16) from the at least one second reactor (86) to the at least one cooling section (22, 22′) in which the conveyed decarbonated particles (16) release a portion of their thermal energy;
introducing a gas to the at least one second reactor (86), wherein the gas may comprise steam and/or one or more gases which are substantially free of carbon;
venting the gas from the at least one second reactor (86) to the reactor (8) (e.g., via a direct venting therebetween);
separating the gas vented from the at least one second reactor (86) from one or more gasses (14, 14′) in a cooling section (22, 22′);
directly venting the gas from the from the at least one second reactor (86) to the reactor (8);
fluidising decarbonized particles (16) leaving the reactor (8) in the at least one second reactor (86) using the gas within the at least one second reactor (86).

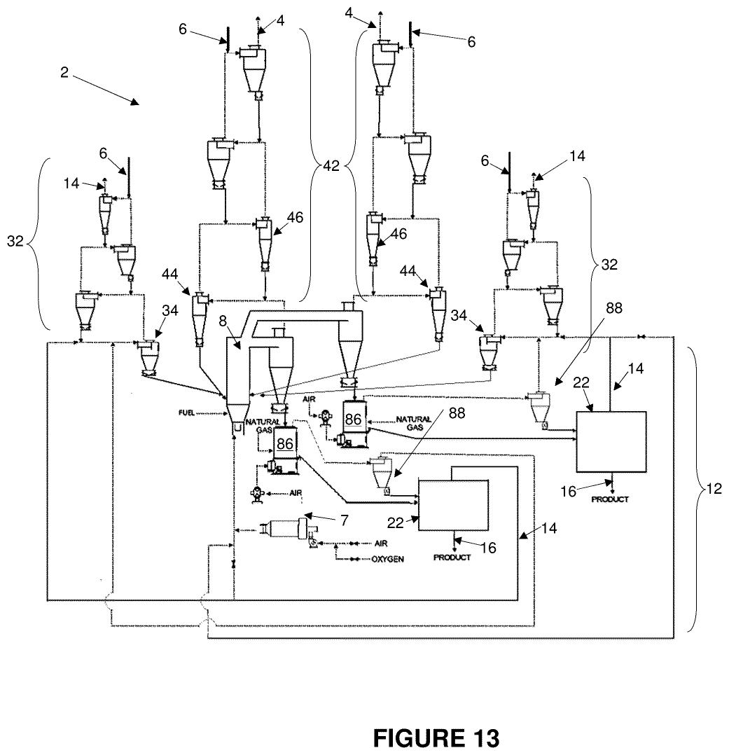

As suggested by FIGS. 13-15, according to some embodiments, a device for the decarbonation of limestone, dolomite or other carbonated materials may comprise one or more additional features or technical elements for scaling up for increased throughput of processing. In this regard, a larger throughput through the device may be achieved. Scaling-up of the device may be desirable in that it may enable sufficient decarbonization of a large amount of carbonated particles 6 delivered to the device. This may be accomplished, for example, by providing a plurality of second reactors (86), a plurality of pre-heating cyclone strings (42), a plurality of cooling cyclone strings (e.g., a plurality of cooling sections (22, 22′) and/or cooler units (61, 62)), equipment to distribute material between different components within the device, or a combination thereof, without limitation.

For example, in some embodiments, a process of using the device and/or for decarbonizing limestone, dolomite or other carbonated materials may comprise one or more the following steps in any combination:
heating particles of carbonated materials (6) in a reactor (8) of a first circuit (2) up to a temperature range in which carbon dioxide of the carbonated materials is released to obtain decarbonated particles (16) comprising CaO and/or MgO;
conveying particles of carbonated materials (6) by a first entraining gas (4) in one or a plurality of primary pre-heating sections (42) of the first circuit (2) for preheating said carbonated materials (6);
conveying particles of carbonated materials (6) from the reactor (8) to one or a plurality of second reactors (86) located downstream of the reactor (8);
transferring the decarbonated particles (16) to one or a plurality of cooling sections (22) of a second circuit (12) comprising a second entraining gas (14), in which the conveyed decarbonated particles (16) release a portion of their thermal energy;
splitting the particles of carbonated materials (6) from the reactor (8) into two or more streams downstream of the reactor (8);
feeding each of the two or more streams to a separate second reactors (86);
transferring the decarbonated particles (16) to two separate cooling sections (22) of the second circuit (12);
conveying at least a portion of the second entraining gas (14) back to the reactor (8);
conveying particles of carbonated materials (6) from each of the one or plurality of primary pre-heating sections (42) of the first circuit (2) to the reactor (8);
conveying at least a portion of the second entraining gas (14) back to at least one heating section (32) of the second circuit (12);
conveying at least a portion of the second entraining gas (14) to a solid/gas suspension heat exchanger (34) in at least one heating section (32) of the second circuit (12).

In some embodiments, each of two cooling sections (22) may comprise a cooling tower comprised of a plurality of solid/gas suspension heat exchangers (24) (e.g., as suggested in FIGS. 1, 4, 5, 16, 18, 19, 21 and 22), without limitation. In some embodiments, each of the primary pre-heating sections (42) of the first circuit (2) may comprise a pre-heating tower comprised of a plurality of solid/gas suspension heat exchangers (44, 46), without limitation.

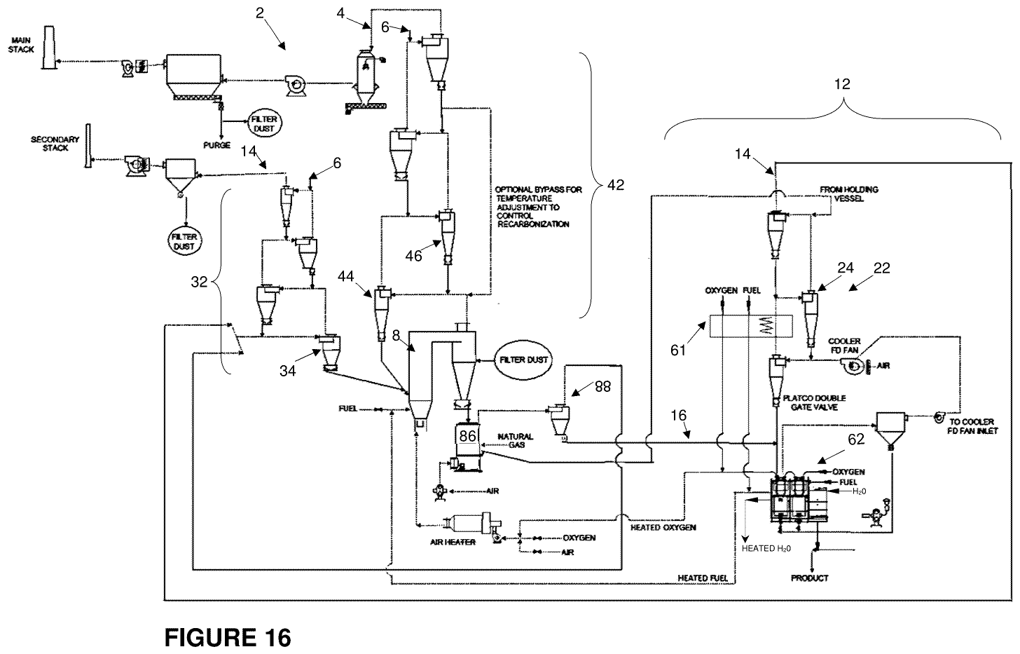

As suggested by FIG. 16, according to some embodiments, a device for the decarbonation of limestone, dolomite or other carbonated materials may comprise means for oxygen and fuel preheating using waste heat (e.g., heat derived from hot CaO produced).

For example, in some embodiments, a process of using the device and/or for decarbonizing limestone, dolomite or other carbonated materials may comprise one or more the following steps in any combination:
heating particles of carbonated materials (6) in a reactor (8) of a first circuit (2) up to a temperature range in which carbon dioxide of the carbonated materials is released to obtain decarbonated particles (16) comprising CaO and/or MgO;
conveying particles of carbonated materials (6) by a first entraining gas (4) in the first circuit (2) for preheating said carbonated materials (6);
transferring the decarbonated particles (16) to a cooling section (22) of a second circuit (12) comprising a second entraining gas (14) in which the conveyed decarbonated particles (16) release a portion of their thermal energy;
introducing fuel and/or oxygen through at least one indirect heat exchanger (61, 62) within the cooling section (22) of the second circuit (12);
cooling the decarbonated particles (16) in a second indirect heat exchanger (62) within the cooling section (22) of the second circuit (12) by virtue of heat transfer from the decarbonated particles (16) to fuel and/or oxygen introduced to said second indirect heat exchanger (62);
cooling the decarbonated particles (16) in a first indirect heat exchanger (61) within the cooling section (22) of the second circuit (12) by virtue of heat transfer between a second entraining gas (14) flow through the cooling section (22) to the fuel and/or oxygen introduced to said first indirect heat exchanger (61);
delivering heated fuel and/or oxygen to the reactor (8) from the at least one indirect heat exchanger (61, 62);
combining heated fuel and/or oxygen leaving a plurality of indirect heat exchangers (61, 62) (as suggested in FIG. 16);
providing a secondary flow of fuel to the reactor (8) to supplement said heated fuel delivered to the reactor (8) from the at least one indirect heat exchanger (61, 62);
providing a secondary flow of oxygen to the reactor (8) to supplement said heated oxygen delivered to the reactor (8) from the at least one indirect heat exchanger (61, 62);
introducing water to the second indirect heat exchanger (62), and further cooling the decarbonated particles (16) by way of heat transfer from the decarbonated particles (16) to the water.

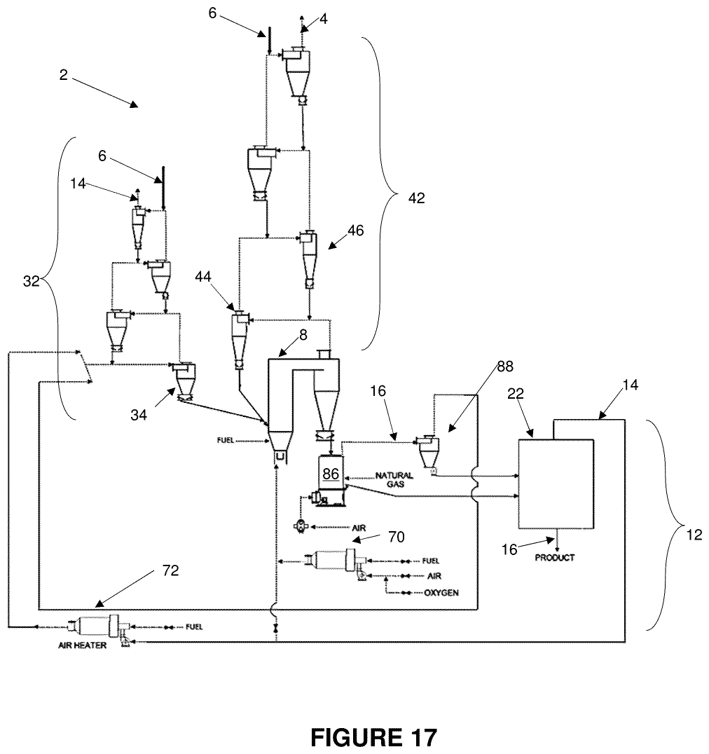

As suggested by FIG. 17, according to some embodiments, a device for the decarbonation of limestone, dolomite or other carbonated materials may comprise a re-heating of cooling gas in order to reduce oxygen consumption by the device during the process.

For example, in some embodiments, a process of using the device and/or for decarbonizing limestone, dolomite or other carbonated materials may comprise one or more the following steps in any combination:
heating particles of carbonated materials (6) in a reactor (8) of a first circuit (2) up to a temperature range in which carbon dioxide of the carbonated materials is released to obtain decarbonated particles (16) comprising CaO and/or MgO;
conveying particles of carbonated materials (6) by a first entraining gas (4) in the first circuit (2) for preheating said carbonated materials (6);
transferring the decarbonated particles (16) to a cooling section (22) of a second circuit (12) comprising a second entraining gas (14) in which the conveyed decarbonated particles (16) release a portion of their thermal energy;
heating the second entraining gas (14) by virtue of the conveyed decarbonated particles (16) releasing a portion of their thermal energy and transferring it thereto;
supplementally heating the second entraining gas (14) downstream of the cooling section (22) of the second circuit (12) (e.g., via one or more supplementary hot gas generators (72));
conveying supplementally-heated second entraining gas (14) to a heating section (32) of the second circuit (12) positioned downstream of said cooling section (22) and upstream of the reactor (8);
heating particles of carbonated materials (6) in the heating section (32) of the second circuit (12) using the supplementally-heated second entraining gas (14);
delivering heated particles of carbonated materials (6) from the heating section (32) of the second circuit (12) to the reactor (8);
introducing fuel to a burner (e.g., of one or more supplementary hot gas generators (72)) to directly or indirectly heat the second entraining gas (14) downstream of the cooling section (22) of the second circuit (12);
introducing current to a filament to provide electric heat in a flow of the second entraining gas (14);
reducing a heat input loading on the reactor (8) by virtue of supplementally heating the second entraining gas (14) downstream of the cooling section (22) of the second circuit (12);
reducing a flow of fuel to the reactor (8) by virtue of supplementally heating the second entraining gas (14) downstream of the cooling section (22) of the second circuit (12);
reducing a required flow of oxygen to the reactor (8) by virtue of supplementally heating the second entraining gas (14) downstream of the cooling section (22) of the second circuit (12) and preheating said carbonated particles (6) in a heating section (32) of the second circuit (12);
reducing a residence time of carbonated particles (6) in the reactor (8) by virtue of supplementally heating the second entraining gas (14) downstream of the cooling section (22) of the second circuit (12) and preheating said carbonated particles (6) in a heating section (32) of the second circuit (12).

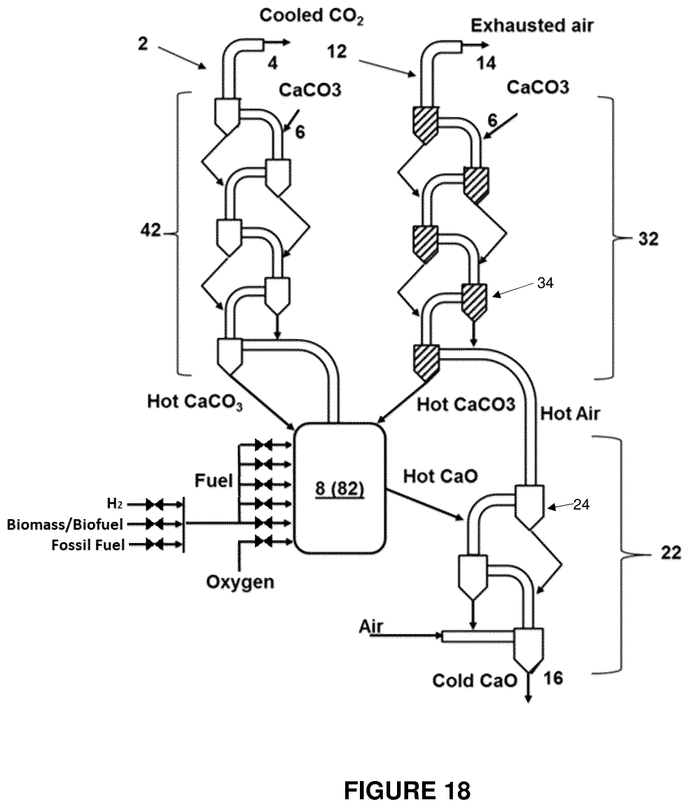

As suggested by FIGS. 18-20, according to some embodiments, a device for the decarbonation of limestone, dolomite or other carbonated materials may be configured for fuel flexibility and/or may comprise an ability to switch from fossil fuel to either solid fuel (e.g., biomass) and/or hydrogen; wherein partial or complete firing may be established, without limitation.

For example, in some embodiments, a process of using the device and/or for decarbonizing limestone, dolomite or other carbonated materials may comprise one or more the following steps in any combination:
heating particles of carbonated materials (6) in a reactor (8) of a first circuit (2) up to a temperature range in which carbon dioxide of the carbonated materials is released to obtain decarbonated particles (16) comprising CaO and/or MgO;
providing oxygen to the reactor (8);
providing fuel to the reactor (8);
combusting the fuel and oxygen within the reactor;
adjusting and/or controlling the composition of fuel provided to the reactor (8);
selecting a composition of fuel from one or more of the following group: hydrogen gas, solid fuel, biofuel, biomass, a fossil fuel, and natural gas;
maintaining process gas in the reactor (8) between approximately 1100 and 1300° C.
maintaining process gas in the reactor (8) to within a 200° C. maximum temperature differential;
providing fuel to the reactor (8) at a plurality of different fuel entrance points along the reactor (8);
providing fuel to the reactor (8) at a higher elevation than an elevation where the oxygen is provided to the reactor (8);
providing more fuel to the reactor (8) at higher elevations of the reactor (8);
providing a first type of fuel to the reactor (8); and then providing a second type of fuel to the reactor (8);
periodically switching between the first and second types of fuels delivered to the reactor (8);
selecting the first type of fuel to be substantially different in composition than the second type of fuel;
selecting the first type of fuel to be a solid fuel comprising biomass and selecting the second type of fuel to comprise hydrogen gas, a fossil fuel, and/or natural gas;
providing fuel to the reactor (8) at a plurality of different fuel entrance points along the reactor (8);
providing a first type of fuel at one of the plurality of different fuel entrance points along the reactor (8);
providing another second type of fuel at another one of the plurality of different fuel entrance points along the reactor (8) which is substantially different in composition than the first type of fuel;
adjusting and/or controlling the flow of fuel to the reactor (8) at each of the plurality of different fuel entrance points along the reactor (8);
selecting the first type of fuel and the second type of fuel such that they are substantially different in composition, wherein each of the first type of fuel and second type of fuel are selected from one or more of the following: hydrogen gas, solid fuel, biofuel, biomass, a fossil fuel, and natural gas;
introducing the first type of fuel to the reactor (8) at a lower one of a plurality of different fuel entrance points along the reactor (8), and introducing the second type of fuel to the reactor (8) at a location of the reactor (8) which is located above the first fuel type (i.e., above said lower one of a plurality of different fuel entrance points along the reactor (8));
providing a third type of fuel at one of a plurality of different fuel entrance points along the reactor (8); wherein
   the first type of fuel comprises a solid fuel comprising biomass;
   the second type of fuel comprises hydrogen gas; and
   the third type of fuel comprises a fossil fuel, and/or natural gas;
   the first type of fuel is introduced to the reactor (8) at a first fuel entrance point;
   the second type of fuel is introduced to the reactor (8) at a second fuel entrance point;
   the third type of fuel is introduced to the reactor (8) at a third fuel entrance point;
   the first entrance point is located below the second entrance point; and the second entrance point is located below the third entrance point;
heating oxygen using a hot gas generator (70) to produce heated oxygen;
providing the heated oxygen from the hot gas generator (70) to the reactor (8);
providing fuel to the hot gas generator (70);
combusting the fuel within the hot gas generator (70);
adjusting and/or controlling the composition of fuel provided to the hot gas generator (70);
selecting said composition of fuel provided to the hot gas generator (70) from one or more of the following group: hydrogen gas, solid fuel, biofuel, biomass, a fossil fuel, and natural gas;
providing at least two independent sources of fuel; the composition of each of the at least two independent sources of fuel being different from one another;
   providing means for controlling a flow of each of the independent sources of fuel to the hot gas generator (70);
   adjusting the means for controlling a flow of each of the independent sources of fuel to the hot gas generator (70);
   controlling a composition of fuel delivered to the hot gas generator (70).

In some embodiments, the at least two independent sources of fuel to the hot gas generator (70) comprises a first source of fuel, a second source of fuel, and a third source of fuel. The first source of fuel may comprise hydrogen gas; the
second source of fuel may comprise a solid fuel (e.g., one comprising biomass, plastic particulate, lignite, and/or bituminous coal); and the third source of fuel may comprise a fossil fuel and/or natural gas. Vented first entraining gas 4 may be used to suspend the solid fuel and/or pneumatically convey it to the hot gas generator (70).

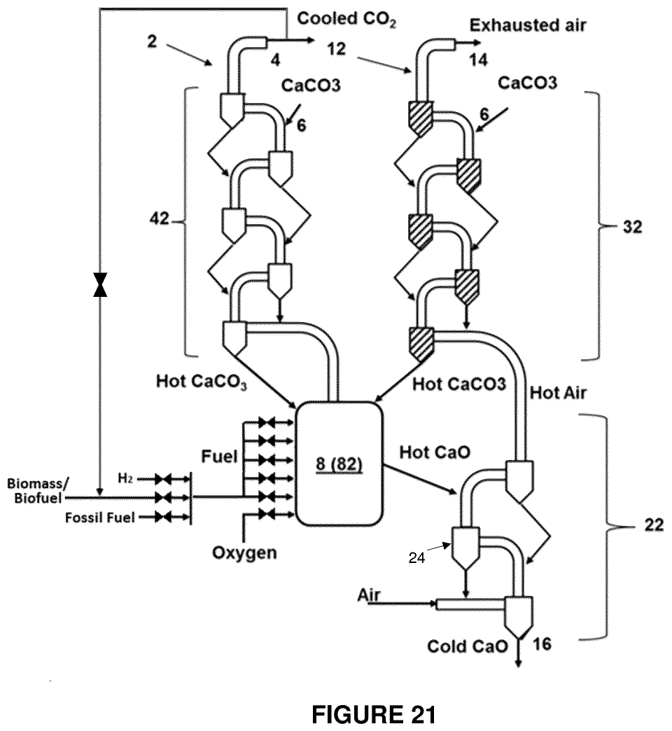

As suggested by FIGS. 21-23, according to some embodiments, a device for the decarbonation of limestone, dolomite or other carbonated materials may comprise means for solid fuel feeding to the reactor (8) and/or to a hot gas generator (70) using a nitrogen-free gas. The nitrogen-free gas may be used to pneumatically-transport or assist in injecting a solid fuel into the reactor.

For example, in some embodiments, a process of using the device and/or for decarbonizing limestone, dolomite or other carbonated materials may comprise one or more the following steps in any combination:
heating particles of carbonated materials (6) in a reactor (8) of a first circuit (2) up to a temperature range in which carbon dioxide of the carbonated materials is released to obtain decarbonated particles (16) comprising CaO and/or MgO;
providing oxygen to the reactor (8);
providing a solid fuel to the reactor (8);
combusting the solid fuel and oxygen within the reactor (8) to produce a first entraining gas (4);
using at least a portion of the first entraining gas (4) to pneumatically convey the solid fuel to the reactor (8);
   selecting a solid fuel comprising biomass;
   selecting a solid fuel that is configured in a particulate form which is capable of being pneumatically-conveyed by the first entraining gas (4);
controlling a flow of the first entraining gas (4) used to pneumatically convey the solid fuel to the reactor (8);
   diverting at least a portion of the first entraining gas (4) from a location which is downstream of a first pre-heating section (42) of the first circuit (2) to pneumatically convey the solid fuel to the reactor (8);
diverting at least a portion of the first entraining gas (4) from a location which is upstream of a main stack to pneumatically convey the solid fuel to the reactor (8);
   drying the first entraining gas (4) to remove a water vapor component thereof prior to pneumatically conveying the solid fuel to the reactor (8);
   heating oxygen in a hot gas generator (70) to provide heated oxygen;
   providing heated oxygen from the hot gas generator (70) to the reactor (8);
   providing a solid fuel to the hot gas generator (70) for combustion;
   using at least a portion of a first entraining gas (4) produced by the reactor (8) to pneumatically convey the solid fuel to the hot gas generator (70);
   diverting a portion of first entraining gas (4) from a location downstream of a pre-heating section (42) of the first circuit (2) and pneumatically conveying solid fuel to
   the hot gas generator (70) using the diverted portion of the first entraining gas (4) diverted from the location downstream of a pre-heating section (42) of the first circuit (2).

In some embodiments, the first entraining gas (4) may comprise flue gas containing carbon dioxide. In some embodiments, the first entraining gas (4) may comprise flue
gas which is substantially free of nitrogen.

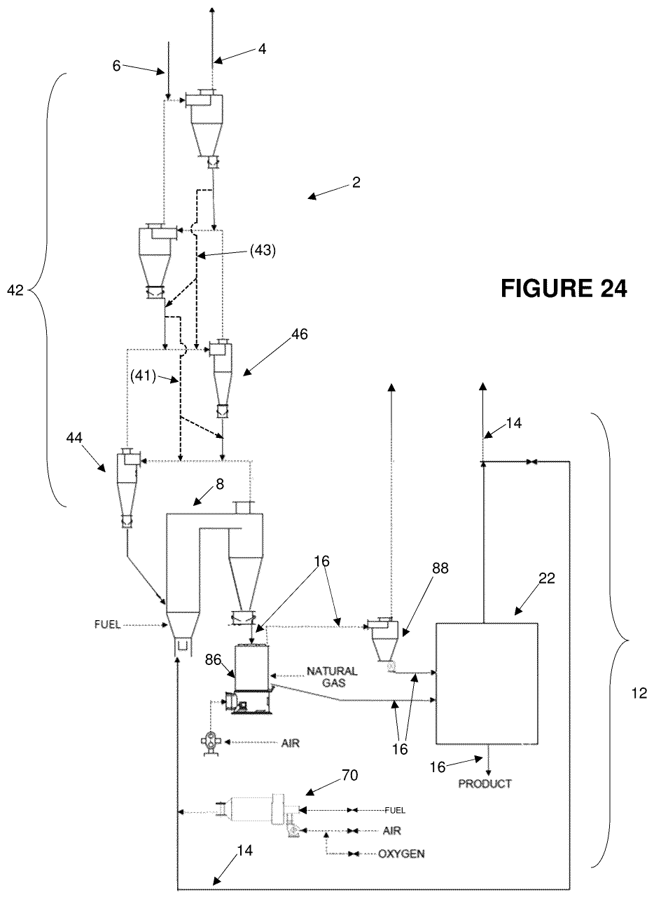

As suggested by FIGS. 24-31, according to some embodiments, a device for the decarbonation of limestone, dolomite or other carbonated materials may comprise one or more of the following technical features:
a first circuit (2) in which a first entraining gas (4) conveys carbonated materials (6), the first circuit (2) comprising a reactor (8) in which said carbonated materials (6) are heated to a temperature range in which carbon dioxide is released to obtain decarbonated materials (16) comprising CaO and/or MgO;
a second circuit (12) in which a second gas (14) is circulated, the second circuit (12) comprising a cooling section (22) in which the decarbonated materials (16) transferred from the first circuit (2), release a portion of their thermal energy to the second gas (14); and
a bypass (41, 43, 45, 47, 49) extending between a first location and a second location, the bypass (41, 43, 45, 47, 49) being configured for conveying carbonated materials (6) from the first location to the second location;
wherein the first location is proximate to one of: i) a feed of carbonated materials (6) to a pre-heating section (42) of the first circuit (2), ii) a lower discharge of a solid/gas suspension exchanger within a pre-heating section (42) of the first circuit (2), iii) a lower discharge of a solid/gas suspension exchanger within a pre-heating section (32) of the second circuit (12);
wherein the second location is more proximate to the reactor (8) and/or to the source of the first entraining gas (4) than the first location and comprises a higher temperature than the first location;
wherein the bypass (41, 43, 45, 47, 49) is configured to allow carbonated materials (6) to bypass or circumvent at least one intermediate solid/gas suspension exchanger in the pre-heating section (42) of the first circuit (2);
wherein the bypass (41, 43, 45, 47, 49) is configured to minimize recarbonizing of decarbonated materials (16) exhausted from the reactor (8) and/or residing within the pre-heating section (42) of the first circuit (2); and
wherein the bypass (41, 43, 45, 47, 49) is configured to allow a temperature profile within at least a portion of the pre-heating section (42) to be controlled and/or modified by virtue of the first entraining gas (4) releasing a portion of its thermal energy to the carbonated materials (6) being transferred to the second location from the first location via the bypass (41, 43, 45, 47, 49).

In some embodiments, the device may further comprise a plurality of said bypass (41, 43, 45, 47, 49). In some embodiments, each of the plurality of said bypass (41, 43, 45, 47, 49) may extend from a different first location. In some embodiments, each of the plurality of said bypass (41, 43, 45, 47, 49) may extend to a different second location. In some embodiments, at least two of the plurality of said bypass (41, 43, 45, 47, 49) may extend to the same second location. In some embodiments, at least two of
the plurality of said bypass (41, 43, 45, 47, 49) may fluidly communicate and/or intersect at a junction or node to form a combined bypass (45). In some embodiments, the second location may be located at, proximate to, or upstream of an inlet (44.1, 46.1) to a lower solid/gas suspension exchanger (44, 46) provided within the pre-heating section (42) of the first circuit (2). In some embodiments, the at least one intermediate solid/gas
suspension exchanger may be provided above a lower solid/gas suspension exchanger (44, 46) within the pre-heating section (42) of the first circuit (2). In some embodiments, the carbonated materials (6) conveyed from the first location may have a lower temperature than carbonated materials (6) or the first entraining gas (4) upstream the second location. In some embodiments, the second gas (14) may be an entraining gas.

Moreover, as suggested by FIGS. 24-31, according to some embodiments, a process for the decarbonation of limestone, dolomite or other carbonated materials, may comprise one or more of the following steps:
heating carbonated materials (6) in a reactor (8) of a first circuit (2) up to a temperature range in which carbon dioxide of the carbonated materials is released to obtain decarbonated materials (16) comprising CaO and/or MgO;
conveying carbonated materials (6) by a first entraining gas (4) in the first circuit (2) for preheating said carbonated materials (6) within a pre-heating section (42) of the first circuit (2);
conveying carbonated materials (6) from a lower temperature first location to a higher temperature second location within the pre-heating section (42) of the first circuit (2) using a bypass (41, 43, 45, 47, 49); wherein the second location is provided more proximate to the reactor (8) and/or to a source of the first entraining gas (4) than the first location;
allowing the conveyed carbonated materials (6) to bypass or circumvent at least one intermediate solid/gas suspension exchanger within the pre-heating section (42) of the first circuit (2);
transferring heat from the first entraining gas (4) to carbonated materials (6) conveyed to the second location from the first location;
modifying and/or controlling a temperature profile within at least a portion of the pre-heating section (42) of the first circuit (2); and
by virtue of modifying and/or controlling a temperature profile within at least a portion of the pre-heating section (42) of the first circuit (2), minimizing recarbonizing of decarbonated or partially-decarbonated materials exhausted from the reactor (8) and/or residing within the pre-heating section (42) of the first circuit (2).

In some embodiments, the process may further comprise the step of repositioning a recarbonizing zone within the pre-heating section (42) to a location more downstream of the reactor (8), to a location further away from the reactor (8), to a location higher in the pre-heating section (42), and/or to a location within the pre-heating section
(42) which reduces or minimizes build-up, scaling, or sticking of material within the pre-heating section (42) caused by recarbonizing of said de-carbonated or partially-decarbonated materials.

In some embodiments, the process may further comprise the step of minimizing the formation of one or more high temperature zones within the pre-heating
section (42) of the first circuit (2), reducing one or more high temperature zones within the pre-heating section (42) of the first circuit (2), and/or moving a high temperature zone within the pre-heating section (42) of the first circuit (2).

In some embodiments, the process may further comprise the step of selectively cooling a feed to one or more solid/gas suspension exchangers (44, 46) provided within the pre-heating section (42) of the first circuit (2) and below the at least one intermediate solid/gas suspension exchanger, with carbonated materials (6) conveyed by the bypass (41, 43, 45, 47, 49).

A system for the decarbonation of limestone, dolomite or other carbonated materials may, according to some embodiments (e.g., FIGS. 1, 18, 19, 21, 22), comprise a first circuit (2) and a second circuit (12). The first circuit (2) may be configured for heating carbonated particles (6) and may comprise a preheating section (42) configured to convey the carbonated particles (6) to a reactor (8). The preheating section (42) may comprise at least one solid/gas suspension heat exchanger (44, 46). The preheating section (42) may also comprise a first entraining gas (4) substantially free of nitrogen
circulating within the preheating section (42). The first entraining gas (4) may be configured to heat the carbonated particles (6) in the preheating section (42). The first circuit (2) may comprise a reactor (8) configured to heat said particles (6) to a temperature range in which carbon dioxide of the carbonated particles (6) is released to obtain decarbonated particles (16) comprising CaO and/or MgO. The reactor (8) may
be configured to produce the first entraining gas (4) within the preheating section (42), for example, by combusting fuel and substantially pure oxygen therein. The reactor (8) may comprise an oxygen entrance point being located at a first location of the reactor
(8). It may also comprise a plurality of fuel entrance points separated from the oxygen entrance point. The reactor (8) may comprise a temperature gradient of process gas throughout the reactor (8). The temperature gradient of process gas may have a minimum temperature and a maximum temperature.

The second circuit (12) may be provided downstream of the reactor (8) of the first circuit (2) and is preferably configured to receive decarbonated particles (16) from the first circuit (2) and cool the decarbonated particles (16). The second circuit (12)
may comprise a cooling section (22) configured to cool the decarbonated particles (16) received from the first circuit (2). The cooling section (22) may comprise a second entraining gas (14) substantially free of carbon dioxide circulating within the cooling section (22). The second entraining gas may be configured to cool the decarbonated particles (16) in the cooling section (22). The second circuit (12) may comprise means
for delivering the second entraining gas (14) to the cooling section (22) of the second circuit (12).

The system may also comprise a source of substantially pure oxygen. It may also comprise means for delivering substantially pure oxygen from the source of substantially pure oxygen to the oxygen entrance point of the reactor (8). It may also
comprise at least one source of fuel. It may also comprise means for delivering fuel from the at least one source of fuel to each of the plurality of fuel entrance points of the reactor (8).

Each of the plurality of fuel entrance points may be configured to be independently adjustable and/or controllable in order to vary or restrict a flow of fuel therethrough. Each of the plurality of fuel entrance points may be spaced from one another along the reactor (8). Each of the plurality of fuel entrance points are preferably located above the first location of the oxygen entrance point to the reactor (8).

The oxygen entrance point may be configured to receive substantially pure oxygen from the source of substantially pure oxygen. Each of the plurality of fuel entrance points may be configured to receive fuel from the at least one source of fuel. The plurality of fuel entrance points may each be independently set, adjusted, or configured such that resulting flow paths of fuel to the reactor (8) are restricted to a configuration that limits a maximum temperature difference of process gas distributed throughout the reactor (8) to less than 200° C. Said differently, the plurality of fuel entrance points may each be independently set, adjusted, or configured such that resulting flow paths of fuel to the reactor (8) are restricted to a configuration such that the difference between said minimum temperature and maximum temperature within the temperature gradient of process gas throughout the reactor (8) is less than 200° C.

A system for the decarbonation of limestone, dolomite or other carbonated materials may, according to some embodiments, comprise a first circuit (2) comprising: a first entraining gas (4) substantially free of nitrogen, particles (6) of a carbonated mineral, and a reactor (8). The reactor (8) may be configured to produce decarbonated particles (16) comprising CaO and/or MgO from the particles (6) of a carbonated mineral,
for example by heating the particles (6) of a carbonated mineral to release carbon dioxide therefrom. The reactor (8) may be configured to produce the first entraining gas (4) by combusting fuel and substantially pure oxygen therein.
   a second circuit (12) may be provided downstream of the first circuit (2). The second circuit (12) may comprise a second entraining gas (14) substantially free of
carbon dioxide. It may also comprise a cooling section (22) configured to cool decarbonated particles (16) produced in and leaving the first circuit (2). It may also comprise a source of first cooling gas. It may also comprise means for delivering the first cooling gas to the cooling section (22) of the second circuit (12). The first cooling gas may be configured to produce or form some or all of the second entraining gas (14).

The second entraining gas (14) may be configured to receive a portion of thermal energy from the decarbonated particles (16) produced in and leaving the first circuit (2) to pre-cool the decarbonated particles (16) produced in and leaving the first circuit (2).

In addition to the first (2) and second (12) circuits, the system may further comprise a third circuit (12′) downstream of the second circuit (12). The third circuit (12′) may comprise a third entraining gas (14′) substantially free of carbon dioxide. The third entraining gas (14′) may comprise a different composition than the first (2) and/or second (14) entraining gases. The third circuit (12′) may comprise a cooling section (22′) configured to supplementally cool pre-cooled decarbonated particles (16) leaving the second circuit (12). It may also comprise a source of second cooling gas. It may also comprise means for delivering the second cooling gas to the cooling section (22′) of the
third circuit (12′). The second cooling gas may be configured to produce or form some or all of the third entraining gas (14′). The third entraining gas (14) may be configured to receive a portion of thermal energy from the pre-cooled decarbonated particles (16) produced in and leaving the second circuit (12) to supplementally cool the pre-cooled decarbonated particles (16) produced in and leaving the second circuit (12).

For example, in some embodiments (FIG. 4), the second cooling gas (delivered to the third circuit (12′)) may comprise air, and the first cooling gas (delivered to the second circuit (12)) may comprise substantially pure oxygen. The system may further comprise means for delivering the third entraining gas (14′) to a heating section (32′) of the third circuit (12′), and means for delivering the second entraining gas (14) to
the reactor (8) of the first circuit. Other features depicted in FIG. 4 may also be provided to the system.

Alternatively, in some embodiments (FIG. 5), the second cooling gas (delivered to the third circuit (12′)) may comprise substantially pure oxygen, and the first cooling gas (delivered to the second circuit (12)) may comprise air. The system may
further comprise means for delivering the third entraining gas (14′) to the reactor (8) of the first circuit (2), and means for delivering the second entraining gas (14) to a heating section (32) of the second circuit (2). Other features depicted in FIG. 5 may also be provided to the system.

### BRIEF DESCRIPTION OF THE FIGURES

Preferred aspects of the invention will now be described in more detail with reference to the appended drawings, wherein same reference numerals illustrate same features.

### LIST OF REFERENCE SYMBOLS

2 First circuit, calcination circuit
4 First entraining gas
6 Carbonated materials (e.g., particles of a carbonated mineral)
8 Reactor/first reactor
12 Second circuit, cooling circuit
12′ Third circuit, cooling circuit
14 Second gas (e.g., second entraining gas)
14′ Third gas (e.g., third entraining gas)
16 Decarbonated particles
22
22′
C section of the second circuit Cooling
o section of the third circuit
o
l
i
n
g
24 (First) solid/gas suspension heat exchanger of the second circuit
32
32′
34
41
42
43
H tion of the second circuit Heating section
e of the third circuit
a (Second) solid/gas suspension heat exchanger of the second circuit
t First bypass (optional)
i Pre-heating section of the first circuit
n Second bypass (optional)
g
s
e
c
44 (First) solid/gas suspension heat exchanger of the first circuit
44.1 inlet of the (first) solid/gas suspension heat exchanger of the first circuit
44.2 outlet of the (first) solid/gas suspension heat exchanger of the first circuit
44.3 return of the (first) solid/gas suspension heat exchanger of the first circuit
45 Third bypass (optional)
46 (Second) solid/gas suspension heat exchanger of the first circuit
46.1 inlet of the (second) solid/gas suspension heat exchanger of the first circuit
46.2 outlet of the (second) solid/gas suspension heat exchanger of the first circuit
46.3
47
49
50
51
52
60
r (second) solid/gas suspension heat exchanger of the first
e circuit
t Combined bypass (optional)
u Crossover bypass (optional)
r Control damper, valve, or equivalent manually—or
n automatically-actuated solids flow control mechanism
Mechanical actuator with optional automated control
o means Temperature sensor (e.g., thermocouple)
f Controller or control system (e.g., Distributed Control System (DCS))
t
h
e
61 (First) (indirect) heat exchanger
62 (Second) (indirect) heat exchanger
70 hot gas generator
72 Supplementary hot gas generator
86 Second reactor
88 Solid/gas separator
90 Recycling passage

### DESCRIPTION OF PREFERRED EMBODIMENTS OF THE INVENTION

FIG. 1 shows a device for the decarbonation of limestone, dolomite or other carbonated materials. In FIG. 1, the carbonated materials 6, such as limestone or
dolomite in form of screened or ground particles, are fed into a first circuit 2, in which a first entraining gas 4 circulates, said gas 4 being the exhaust gas of reactor 8. The particles of carbonated materials 6 are entrained/conveyed to the reactor 8 where the decarbonation takes place under high temperatures. The first entraining gas 4 is preferably substantially-free of nitrogen. This facilitates the final purification of the
exhaust gas 4 into a suitable purity for downstream CO₂ use or sequestration. Furthermore, when the decarbonation is performed in an atmosphere substantially free of nitrogen, a negligible amount of NOx is generated. Indeed, NOx is likely to be formed under heat and in the presence of oxygen and nitrogen, which are the two main constituents of air. Thus, the first circuit 2 is substantially sealed from the ambient air.

The first entraining gas 4 is used to preheat the particles of carbonated materials 6. The first entraining gas 4 mainly results from the CO₂ being released during the decarbonation process in the reactor 8 and from the gas resulting from the combustion coupled to the decarbonation process. It should be noted that the first entraining gas 4 transports the particles of carbonated materials 6 away from the reactor 8, which is a gas
source for the first entraining gas 4 stream. In order to feed the reactor 8 with the particles of carbonated materials 6, a solid/gas separation, preferably an inertial separation is performed in a pre-heating section 42 comprising at least one separator, such as a cyclone. The pre-heating section 42 helps not only to separate the solid materials from the first entraining gas 4, but also enhances heat exchanges. Indeed, the solid particles
6 are efficiently heated by the first entraining gas 4 before being separated thanks to a proper distribution of the solid particles 6 in the gas stream, a vast surface area of the solid particles 6 gets in contact with the gas 4. Consequently, the solid and gas materials reach similar temperature in a very short time (typically a fraction of seconds). This type of heat exchanger is called solid-gas heat exchanger or suspension heat exchanger, and
can typically contain several gas-solid separators to approach a counter-current contact between the first entraining gas 4 and the carbonated particles 6. Once the carbonated particles 6 are decarbonated in the reactor 8, the decarbonated particles 16 are transferred to a second circuit 12.

Embodiments of the process and the device of the present invention ensures that any gas mixture being in direct contact with the CaO/MgO is substantially free of CO₂ in order to avoid any reconversion back to CaCO₃/MgCO₃. Second entraining gas 14 circulating in the second circuit 12 is therefore, substantially free of CO₂. Hence, embodiments of the present invention provides a manner in which to bring the residual amount of carbonate in the product to an acceptable level (e.g. less than 5% in weight), without limitation.

The exchanges of gases 4, 14 between the first 2 and second circuit 12 are minimized using selective separation means (not shown) connecting the first 2 and second circuits 12. The selective separation means are arranged and configured so as
to allow the transfer of the decarbonated particles 16 and carbonated particles 6 between the respective circuits 2, 12, while substantially preventing the passage of gases therebetween. The selective separation means may comprise, without limitation, a siphon element, a loop seal, single or multiple flaps, table feeder, cellular wheel sluice, fluid seal-pot, “Dollar” plate, or any of the following valves: rotary valves, cone valve, J
valve, L valve, trickle valve, or flapper valve.

The second entraining gas 14 is not only used to transport the particles of decarbonated materials 16 but also to cool them in one or more dedicated solid-gas heat exchanger or suspension heat exchangers, in particular gas-solid separators such as a
cyclone or series of cyclones. Then, the heated cooling gas 14 accomplishes the preheating of this portion of the carbonated material 6 in a heating section 32. The heating section 32 is positioned downstream from the cooling section 22 and comprises one or more solid-gas heat exchanger 34 or suspension heat exchangers, in particular gas-solid separators such as a cyclone or series of cyclones. Once separated in the
suspension heat exchangers of the heating section 32, the carbonated material 6 are then directly sent into the calcination zone of the reactor 8.

In FIG. 1, substantially pure oxygen is supplied to the reactor 8 at an oxygen entrance point. The oxygen entrance point being located at a first location of the reactor 8. The reactor 8 further comprises plurality of fuel entrance points, at which fuel is supplied, each of the plurality of fuel entrance points being sequentially-spaced from one another along the reactor 8 and which are each located above the first location of the reactor 8. The flow of fuel to each of the fuel entrance points is adjusted and/or controlled independently from another so as to control the temperature gradient of
process gas throughout the reactor 8 to minimize high temperature zones and maintain a maximum temperature difference of the process gas distributed throughout the reactor 8 to be less than 200° C.

FIG. 2 shows an embodiment with a pre-heating section 42 comprising
at least two cyclones 44, 46. Even a higher number of cyclones can be economically justified, to ensure a more effective preheating of the carbonated material 6 by exploiting the counter current gas-solid contact mode achieved in similar suspension preheaters set-ups described in the state of the art. The pre-heating section 42 is connected to a reactor 8. The reactor 8 may comprise a main combustion chamber connected to and
communicating with an adjacent chamber for collecting the decarbonated particles 16. The adjacent chamber of the reactor 8 is connected to a second reactor 86. The second reactor 86 is supplied with the second entraining gas 14, in particular, air. The second reactor 86 is positioned downstream of the reactor 8 and upstream of a cooling section 22 of a second circuit 12. The second reactor 86 comprises an opening through which
gas from the second reactor 86 can be vented. The vented gas may be filtered in a solid/gas separator 88 located downstream of the second reactor 86 and upstream of the cooling section 22 of the second circuit 12. Carbonated particles 86 removed from the vented gas from the second reactor 86 are transferred to the cooling section 22. The gas discharged from the solid/gas separator 88 can directly be discharged in the
atmosphere. The second reactor 86 is connected to the cooling section 22 via another passage through which the majority of the carbonated particles 86 are transferred. The second entraining gas 14 heated by decarbonated particles 16 in the cooling section 22 may be transferred to an heating section 32 (not illustrated in FIG. 2) for heating the carbonated particles 6.

The supplementary (second) reactor 86 may optionally be equipped with an additional heating source. The additional heating source may be supplied with fuel, such as gas.

The second reactor 86 serves as a vessel for collecting the decarbonated particles 16 transferred from the reactor 8. The second reactor 86 is also used to achieve a residual CO₂<2% in the product and to adjust the product reactivity. An additional benefit of the second reactor 86 is that the temperature and/or the residence time in the first calcination zone (first reactor 8) can be reduced compared to an embodiment without the second reactor 86. This second reactor 86 can also be used to maintain a reductive environment within the second reactor 86 by virtue of at least partially combusting carbon-containing fuel in said second reactor 86. In some embodiments, desulfurization of decarbonated particles 16 may be enhanced by maintaining a reductive environment within the second reactor 86. Reducing conditions may be controlled and/or maintained through the introduction of natural gas or other carbon-containing fuel to the second reactor 86, as depicted.

The embodiment shown in FIG. 2 suggests that a hot gas generator 70, to which substantially pure oxygen can be supplied, may be provided to a device for the decarbonation of limestone, dolomite or other carbonated materials. Heated
substantially pure oxygen may be transferred from the hot gas generator to an oxygen entrance point of the reactor 8. Advantageously, the hot gas generator 70 can be used as a “start-up” heater by temporarily introducing air into the hot gas generator, heating the air, and then supplying the heated air to the reactor 8 during initial commissioning of the reactor 8. After start-up, the air can be switched off and pure oxygen may be
delivered to the hot gas generator 70 for “oxyfuel” normal operating conditions.

The embodiment shown in FIG. 3 differs from that of FIG. 2 in that a heating section 32 of the second circuit 12 is represented. The heating section 32 is positioned downstream from the cooling section 22 and comprises one or more solid-gas heat exchanger or suspension heat exchangers 34, in particular gas-solid separators such as a series of cyclones. As depicted, a portion of heated second entraining gas 14 leaving the cooling section 22 may be delivered to the heating section 32 to heat particles 6 of said carbonated material separately from pre-heating section 42, before they enter reactor 8.

As suggested in FIG. 4, the device for the decarbonation of limestone, dolomite or other carbonated materials may comprise a circuit in which substantially pure oxygen is heated in a cooling section 22 before being fed in the reactor 8. The decarbonation device in FIG. 4 comprises a first circuit 2 (comparable to the first circuit
in FIG. 3), a second 12 and a third circuit 12′ (comparable to the second circuit in FIG. 3). The first circuit 2 in which a first entraining gas 4 substantially free of nitrogen conveys particles 6 of said carbonated mineral, comprises reactor 8. The second circuit 12 in which a second entraining gas 14 substantially free of carbon dioxide is circulated, comprises a cooling section 22 in which the decarbonated particles 16 transferred from
the first circuit 2, release a portion of their thermal energy to the second entraining gas 14. The second entraining gas 14 is substantially pure oxygen and the reactor 8 comprises an oxygen entrance point arranged downstream from the cooling section 22 of the second circuit 12. The third circuit 12′ in which a third entraining gas 14′ substantially free of carbon dioxide is circulated comprises a cooling section 22′ in which the decarbonated particles 16 transferred from the second circuit 12, release a portion
of their thermal energy to the third entraining gas 14′. The third circuit 12′ comprises a heating section 32′ positioned downstream from the cooling section 22′ of the third circuit 12′. The cooling sections 22, 22′ and the heating section 32′ comprise at least one solid/gas suspension heat exchanger 24, 24′, 34′. For clarity, the at least one solid/gas suspension heat exchanger 34′ in the heating section 32′ is not shown in FIG. 4.

The embodiment in FIG. 5 is an alternative to the embodiment of FIG. 4. The decarbonation device in FIG. 5 comprises a first circuit 2 (comparable to the first circuit in FIG. 3), a second circuit 12 (comparable to the second circuit in FIG. 3) and a third circuit 12′. The first circuit 2 in which a first entraining gas 4 substantially free of nitrogen conveys particles 6 of said carbonated mineral, comprises reactor 8. The second circuit 12 in which a second entraining gas 14 substantially free of carbon dioxide is circulated, comprises a cooling section 22 in which the decarbonated particles 16 transferred from the first circuit 2, release a portion of their thermal energy to the second entraining gas 14. The second circuit 12 comprises a heating section 32 positioned
downstream from the cooling section 22 of the second circuit 12. The third circuit 12′ in which a third entraining gas 14′ substantially free of carbon dioxide is circulated comprises a cooling section 22′ in which the decarbonated particles 16 transferred from the second circuit 12, release a portion of their thermal energy to the third entraining gas 14′. The third entraining gas 14′ is substantially pure oxygen and the reactor 8 comprises
an oxygen entrance point arranged downstream from the third circuit 12′. The cooling sections 22, 22′ and the heating section 32 comprise at least one solid/gas suspension heat exchanger 24, 24′, 34. for clarity, the at least one solid/gas suspension heat exchanger 34 in the heating section 32 is not shown in FIG. 5.

The embodiment according to FIG. 6 differs from that of FIG. 3 in that at least some of the first entraining gas 4 is recycled to the reactor 8 via recycling passage 90. This measure permits to control and/or maintain a velocity of the mixture of recycled gas and substantially pure oxygen provided to the reactor 8 within a predetermined velocity range which is sufficient to ensure adequate fluidization of particles.

In the embodiment according to FIG. 7, a filter and at least one fan are provided in a pre-heating section 42 of the first circuit 2. The filter and the fan(s) are located downstream of a first 44 and second 46 solid/gas suspension heat exchanger. The first and the second solid/gas suspension heat exchanger 44, 46 comprise,
respectively, an inlet 44.1, 46.1, an outlet 44.2, 46.2 and a return 44.3, 46.3. In order to prevent ambient air ingress into the pre-heating section 42 at least one of the following measures is implemented:
   a. an operating pressure in the pre-heating section 42 is maintained above a pressure of the ambient air by increasing the pressure (or velocity) of the substantially pure oxygen entering the reactor 8;
   b. an operating pressure in the reactor section 8 is maintained above a pressure of the ambient air by increasing the pressure (or velocity) of substantially pure oxygen entering the reactor 8;
   c. adjusting an RPM speed and/or louver/damper setting of the at least one fan to maintain a pressure in the filter that is above ambient pressure;
   d. adjusting an RPM speed and/or a louver/damper setting of the at least one fan, such that an operating pressure in the reactor 8 is maintained between −1 kPa and +1 kPa.

It should be understood that if two fans are provided (e.g., upstream and downstream of filter as shown), the RPM and/or louver/damper setting of each may be adjusted and/or controlled independently, without limitation.

In the embodiments of FIGS. 8 to 11, different gas venting arrangements of the second reactor 86 are presented.

In the embodiment of FIG. 8, the gas vented from the second reactor 86 is filtered in a solid/gas separator 88 located downstream of the second reactor 86 and upstream of the cooling section 22 of the second circuit 12. The gas filtered is discharged directly in the atmosphere via a stack. Contrary to the embodiment in FIG. 3, the vented gas is not mixed with the second entraining gas 14. Solid decarbonated particles 16
leaving the second reactor 86 and solid/gas separator 88 may be delivered to the cooling section 22 as depicted. As suggested in FIG. 8, some of the vented gas may be recycled back to the second reactor 86.

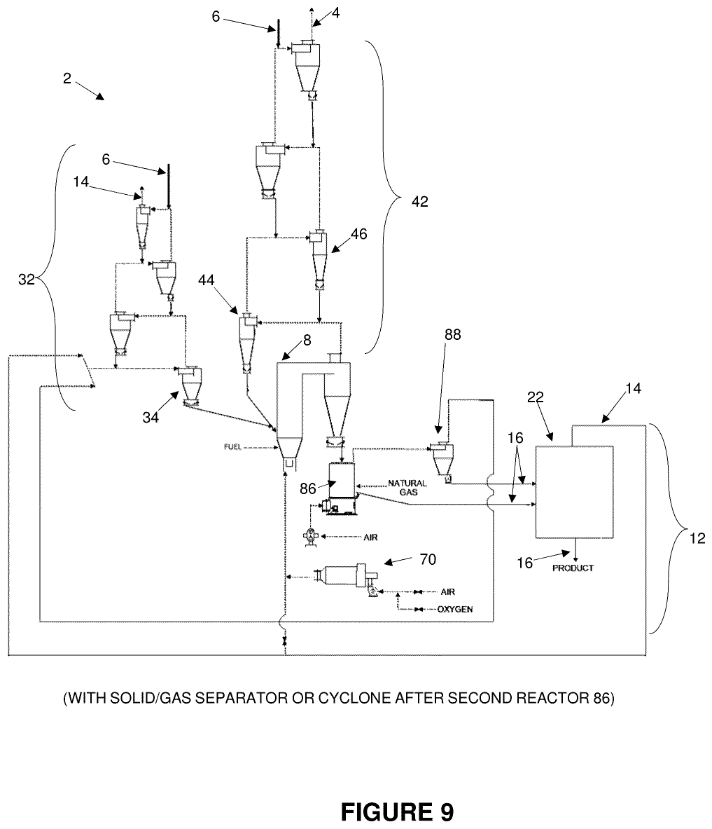

In the embodiment of FIG. 9, the gas vented from the second reactor 86 is filtered in a solid/gas separator 88. The filtered gas may be discharged to a heating 35 section 32 upstream of the cooling section 22. Solid decarbonated particles 16 leaving
the second reactor 86 and solid/gas separator 88 may be delivered to the cooling section 22 as depicted.

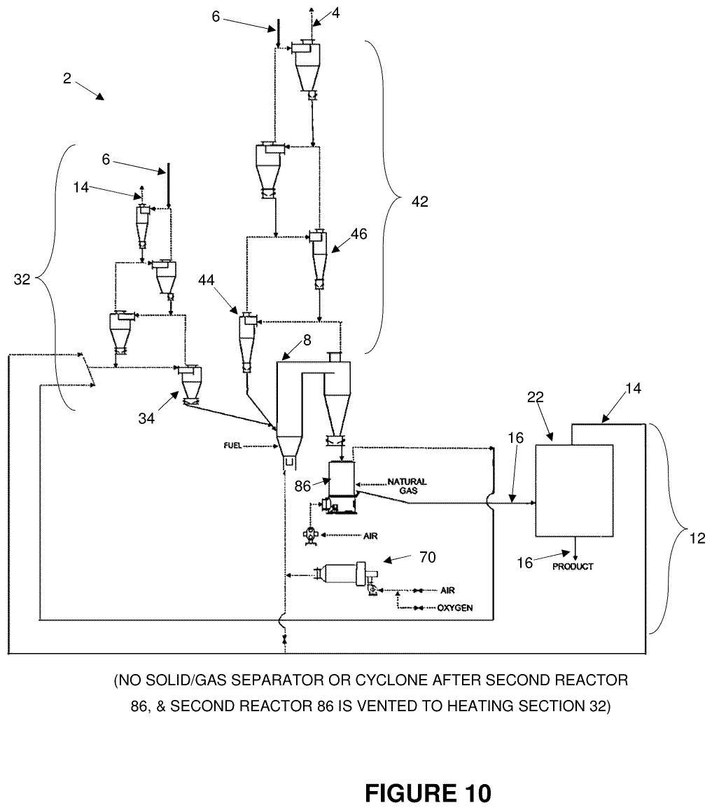

The embodiment of FIG. 10 differs from that shown in FIG. 9 in that there is no solid/gas separator 88 for filtering the gas vented from the second reactor 86. Rather, the gas may be discharged from the second reactor 86 to the heating section 32.

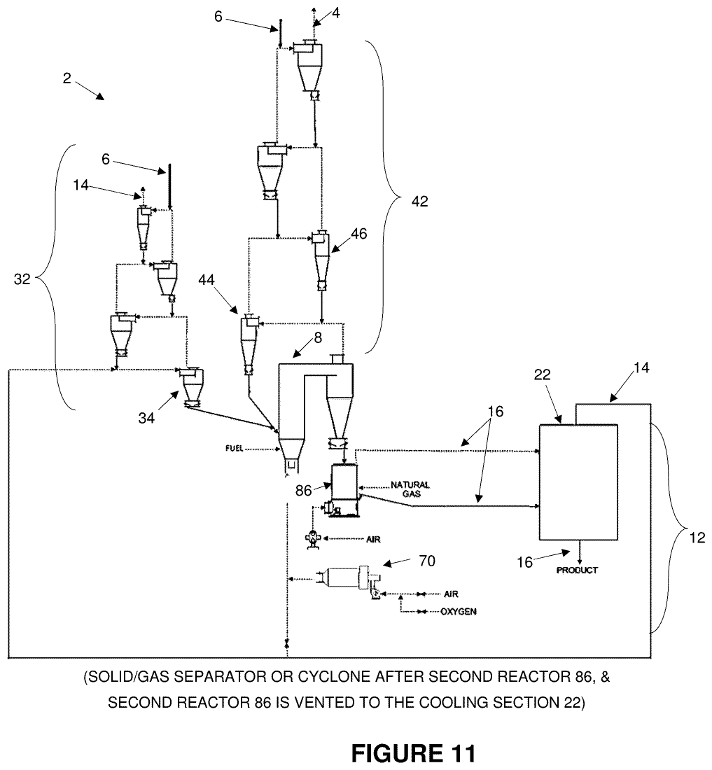

The embodiment of FIG. 11 differs from that of FIG. 8 in that there is no solid/gas separator 88 for filtering the gas vented from the second reactor 86. The vented gas is discharged to the cooling section 22 of the second circuit 12.

In the embodiment of FIG. 12, the gas vented from the second reactor 86 is recycled directly in the reactor 8 of the first circuit 2. In this embodiment, steam,
rather air, is provided to the second reactor 86.

In the embodiment shown in FIG. 13, the pre-heating section 42 of the first circuit 2, and/or the cooling section 22 of the second circuit 12 is duplicated. This duplication may be necessary to handle throughput and/or scaling up to process more
carbonated particles 6. Concerning the first circuit 2, the corresponding two pre-heating sections 42 are connected to the reactor 8. The reactor 8 may comprise a main combustion chamber connected to and communicating with two adjacent chambers for collecting the decarbonated particles 16. Each adjacent chamber of the reactor 8 is connected to a corresponding second reactor 86. Each of the two second reactors 86
can be supplied with the second entraining gas 14, in particular air. The two second reactors 86 are positioned upstream from the two cooling sections 22 of the second circuit 12. The gas (e.g. air or a mixture of air and combustion gas) vented from each second reactor 86 may be filtered in a solid/gas separator 88 located downstream of each second reactor 86 as described above. The vented gas from both second reactors
86 may be discharged to first and second pre-heating sections 42, respectively. The second circuit 12 comprise two heating sections 32 positioned downstream from their respective cooling sections 22. The embodiment shown in FIG. 13 presents a parallelisation, in particular a duplication of the cooling section 22, the heating section 32 and the pre-heating section 42. It can be conceived to have more than two cooling
section 22, two heating section 32 and two pre-heating section 42. The use of plurality of pre-heating/heating/cooling sections allows to increase the capacity of the calciner and/or ease its maintenance. It is anticipated that other permutations of what is shown in FIG. 13 are anticipated. For example, a the decarbonation device may comprise a plurality of pre-heating sections 42, a single reactor 8, one or more second reactors 86, and one or more cooling sections 22. As another example, the decarbonation device
may comprise a plurality of cooling sections 22, a single reactor 8, one or more second reactors 86, and one or more pre-heating sections 42. As yet another example, the decarbonation device may comprise a plurality of second reactors 86, one or more cooling sections 22, a single reactor 8, and one or more pre-heating sections 42, without limitation.

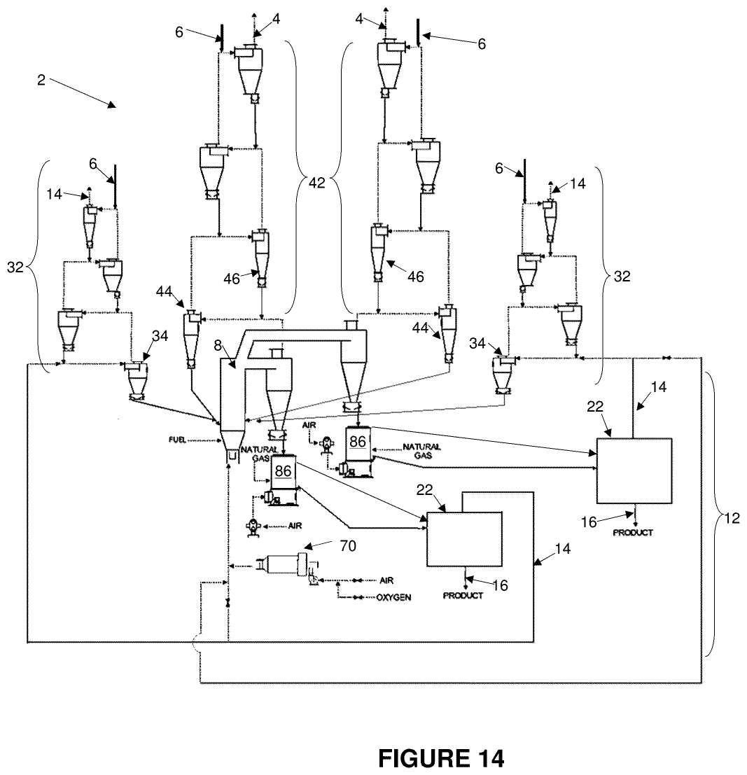

The embodiment of FIG. 14 differs than that of FIG. 13 in that there may be no solid/gas separators 88 filtering gas vented from second reactors 86. Thus, the second reactors 86 may be vented directly to their respective cooling sections 22. For example, the vented gas from each second reactor 86 may enter a bank of cooling
solid/gas suspension heat exchangers 24 in its respective cooling section 22 of the second circuit 12.

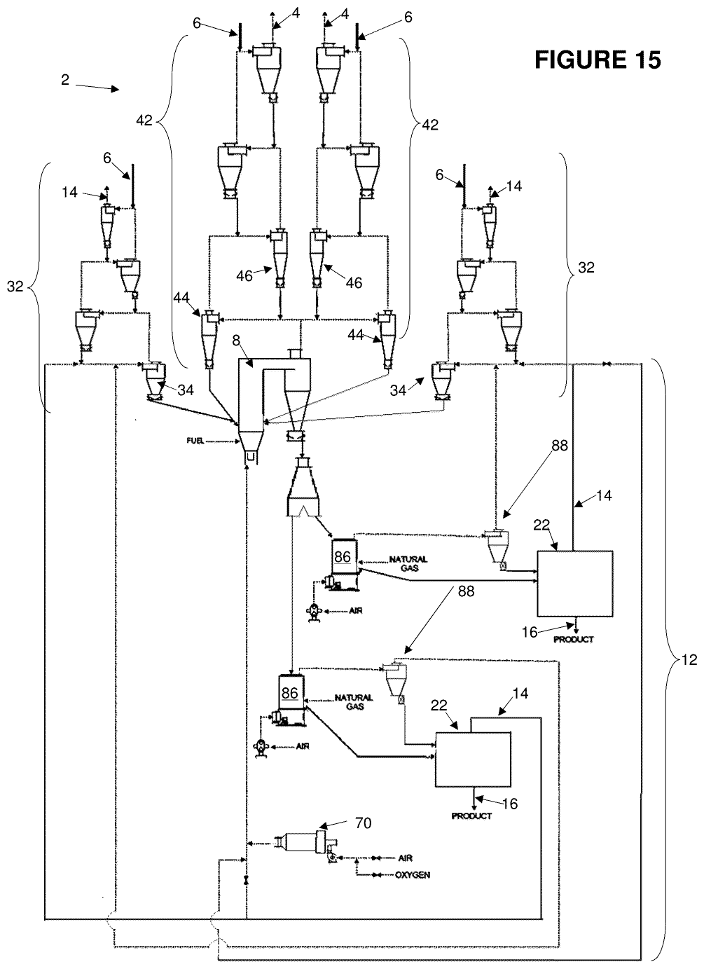

The embodiment of FIG. 15 differs than that of FIG. 13 in that the reactor 8 comprises a single adjacent chamber communication with the two second reaction chamber 86 via a downstream distribution element for distribution the stream of decarbonated particles 16 towards the two second reactors 86 to feed each of the two second reactors 86. As suggested, some of the second entraining gas 14 from one or both of the cooling sections 22 may be recycled to one or more of the heating sections 32 in any conceivable permutation.

The embodiment of FIG. 16 differs than that of FIG. 2 in that a specific design of the cooling section 22 is presented. In particular, cooling section 22 may comprise a bank of one or more suspension heat exchangers 24 (i.e. cyclones). Furthermore, the cooling section 22 may comprise a means (e.g., an indirect heat exchanger), namely a first indirect heat exchanger 61 for heating fuel and/or oxygen used for the reactor 8, using the heat of the second entraining gas 14 circulating in the second circuit 12. Alternatively, or complementary to the above indirect heat exchanger 61, the fuel and/or oxygen used by the reactor 8 can be heated using the sensible heat of the decarbonates particles 16 in a second indirect heat exchanger 62. In
embodiments where both indirect heat exchangers 61, 62 are employed, the heated fuel and/or oxygen from each indirect heat exchanger 61, 62 may be combined together as depicted.

The embodiment of FIG. 17 differs than that of FIG. 3 in that a further
gas heater 72 may be provided between the heating section 32 of the second circuit 12 and the cooling section 22 of the second circuit 12. This measure allows to supplementally increase the temperature of the second entraining gas 14 leaving the cooling section 22 and therefore increases the temperature of the carbonated materials 6 supplied to the reactor 8 via the heating section 32. The measure allows a reduction in
the consumption of substantially pure oxygen in the reactor 8, and/or may reduce the residence time of the carbonated particles 6 in the reactor 8.

The embodiment of FIG. 18 differs than that of FIG. 1 in that the reactor 8 may be supplied with one or more fuel types. Typically, fuel may be selected
from one or more elements of the group consisting of: hydrogen gas; a solid fuel; and a fossil fuel. Supply means are provided to adjust, control, and/or change a composition of the fuel supplied in reactor 8. The composition of the fuel injected can be adjusted by changing the mixing ratio(s) between two or more fuel sources, or completely switch over from one type of fuel to another type of fuel. As depicted, multiple fuel entrance points
to the reactor 8 may be employed. However, it is envisaged that a single fuel entrance point above the oxygen entrance point may be provided.

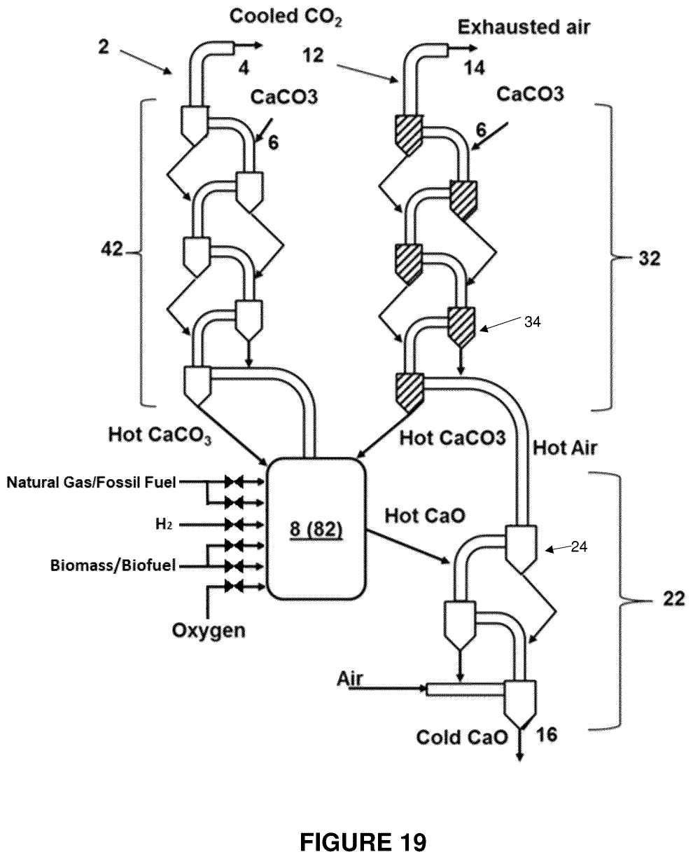

The embodiment of FIG. 19 differs than that of FIG. 1 in that the fuel supply means are adapted to supply a first type of fuel to a first one of a plurality of
different fuel entrance points along the reactor 8 and to supply a second type of fuel to a second one of said plurality of different fuel entrance points along the reactor 8, wherein the second type of fuel being different in composition than the first type of fuel. Typically, a first or second fuel is selected from one or more elements of the group consisting of: hydrogen gas; a solid fuel; and a fossil fuel. In the embodiment shown,
biomass may be used where temperatures of the reactor 8 are typically higher (e.g., near a lower oxygen entrance point). Fossil fuels and/or hydrogen may be used in areas of the reactor 8 where temperatures are less predictable (e.g., further away from the lower oxygen entrance point). It should be understood that while it is not expressly depicted, hydrogen may be provided to the reactor 8 at a location above the fossil fuels.

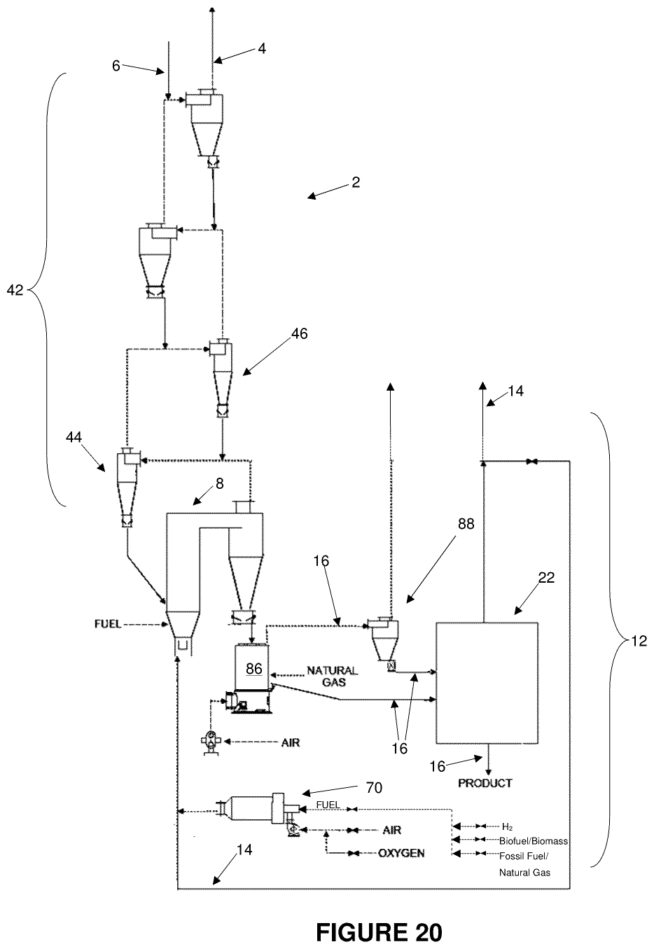

The embodiment of FIG. 20 differs than that of FIG. 2 in that the hot gas generator 70 may be supplied with one or more fuel types. For example, fuel may be selected from one or more elements of the group consisting of: hydrogen gas; a solid fuel; and a fossil fuel. Supply means may be provided which are configured for adjusting,
controlling, and/or changing a composition of the fuel provided to the hot gas generator 70 used to heat oxygen delivered to the reactor 8. The composition of the fuel injected can be adjusted and/or controlled by changing the mixing ratio between two or more fuel sources. Control valves may be switched on and off to change a first type of fuel delivered to the hot gas generator 70 to a second type of fuel delivered to the hot gas
generator 70 which is different from the first type of fuel.

The embodiment of FIG. 21 differs than that of FIG. 18 in that solid fuel is pneumatically conveyed to the reactor 8 by at least a portion of the first entraining gas 4 or a gas substantially free of nitrogen. Typically, the solid fuel comprises particulate
material including, but not limited to, plastics, coal, and/or biomass.

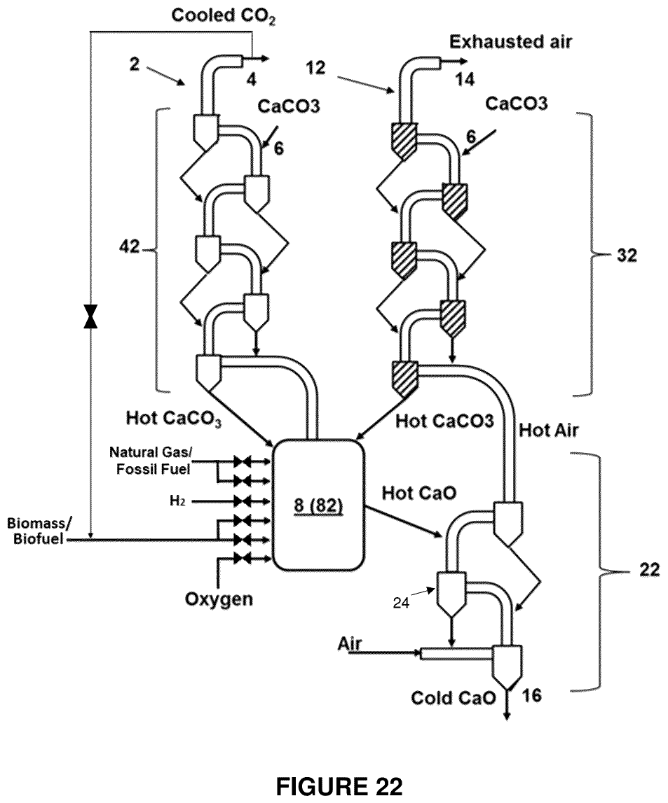

The embodiment of FIG. 22 differs than that of FIG. 19 in that solid fuel is pneumatically conveyed to the reactor 8 by at least a portion of the first entraining gas 4 or a gas substantially free of nitrogen. Typically, the solid fuel comprises particulate
material including, but not limited to, plastics, coal, and/or biomass.

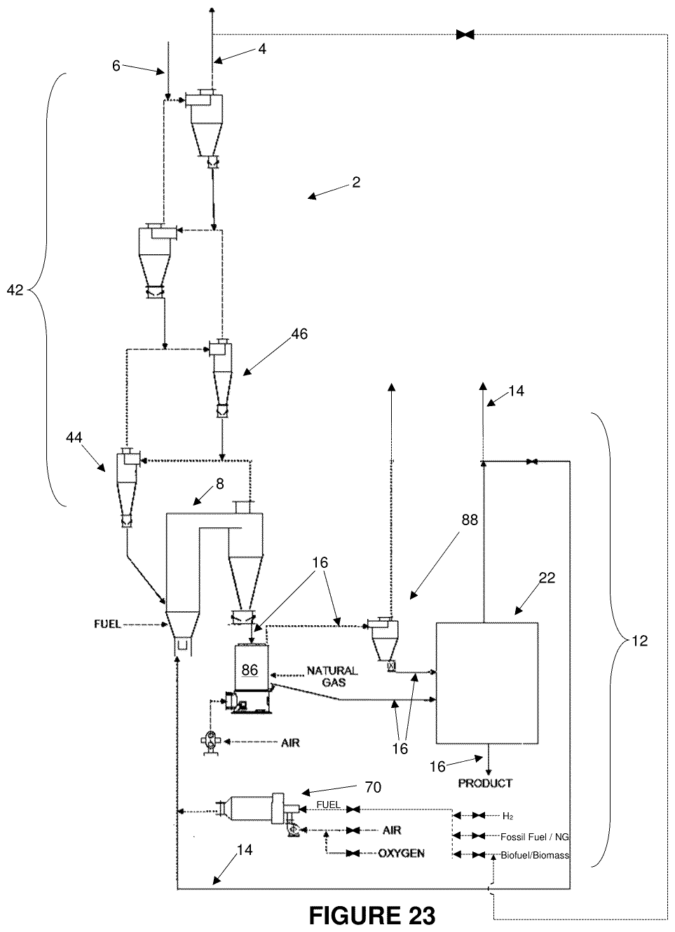

The embodiment of FIG. 23 differs than that of FIG. 20 in that solid fuel is pneumatically conveyed to the hot gas generator 70 using at least a portion of the first entraining gas 4 or a gas substantially free of nitrogen. Typically, the solid fuel
comprises comprise particulate material including, but not limited to, plastics, coal, and/or biomass.

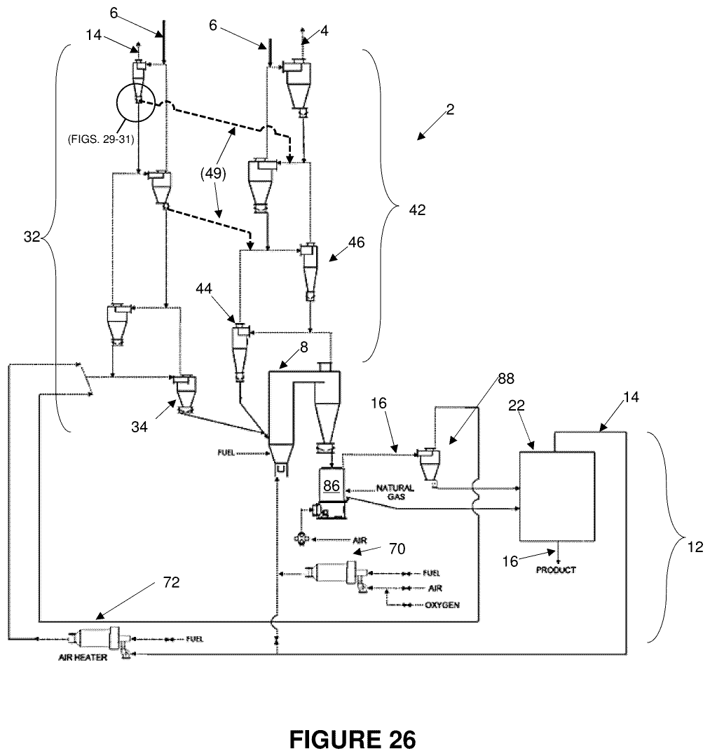

The embodiment of FIG. 24 suggests that for any of the previous embodiments depicted in FIGS. 1-23, carbonated materials 6 in a pre-heating section 42 of the first circuit 2 may be optionally bypassed from one or more first locations to one or more second locations via a bypass 41, 43. In some embodiments, the first location may be adjacent to the discharge of an upper stage within the pre-heating section 42. In some embodiments, the second location may be proximate to a portion of the pre-heating section 42 at or upstream of an entrance to a lower stage within the pre-heating section
42. As depicted, a bypass 41, 43 may be configured to transfer carbonated materials 6 from the first location to the second location, whilst skipping at least one intermediate stage between the upper stage and the lower stage. This may be done in order to modify a temperature profile within the pre-heating section 42 of the first circuit 2 and/or shift a recarbonizing zone within the pre-heating section 42 to a location therein where it has a reduced impact to the overall process. As suggested in FIG. 26, the inventors anticipate
that other pre-heating sections, such as the pre-heating section 32 of the second circuit 12, may include one or more bypasses 49, without limitation.

In the particular embodiment depicted in FIG. 24, carbonated materials 6 discharging from a first solid/gas suspension exchanger within pre-heating section 42
of the first circuit 2 may be transferred to another portion of the pre-heating section 42 (i.e., to a “second location”) within the pre-heating section 42. The second location may be located at and/or anywhere upstream of an inlet 46.1 to a second solid/gas suspension exchanger 46 within the pre-heating section 42. This transfer of carbonated materials 6 from the first location to the second location is accomplished via the provision
and use of one or more optional bypass 41, 43. As shown, an intermediate solid/gas suspension exchanger below/upstream of the first solid/gas suspension exchanger and above/downstream of the second solid/gas suspension exchanger may be bypassed using the bypass 41, 43, without limitation.

In the non-limiting embodiment shown in FIG. 24, there is a first 41 and a second 43 bypass each transferring carbonated materials 6 from a respective first location to a respective second location within the pre-heating section 42. The second location of the first bypass 41 is upstream of an inlet 44.1 to a first solid/gas suspension heat exchanger 44 residing within the pre-heating section 42 of the first circuit 2. The
second location of the second bypass 43 is upstream of an inlet 46.1 to a second solid/gas suspension heat exchanger 46 residing within the pre-heating section 42 of the first circuit 2.

One or both bypasses 41, 43 may be employed or utilized, without limitation. As suggested from the figure, the second location may comprise a portion of the pre-heating section 42 including a primary flow of the first entraining gas 4, and/or the second location may comprise a portion of the pre-heating section 42 including a flow of solids being discharged from a solid/gas suspension heat exchanger within the pre-heating section, without limitation.

Each bypass 41, 43 may be configured to allow carbonated material 6 to skip at least one intermediate solid/gas suspension exchanger as depicted. A respective second location of each bypass 41, 43 will generally have a higher temperature than its respective first location allowing cooler carbonated materials 6 to mix with warmer
carbonated materials 6 at the second location. Carbonated materials 6 may be moved through one or both of the bypasses 41, 43 at any time during the process. Carbonated materials may be moved through a bypass 41, 43 continuously, or on an intermittent basis (as-needed) to control or optimize a temperature profile within the pre-heating section 42 of the first circuit 2.

The bypasses 41, 43 may be configured to reduce the formation of, or move high temperature zones within the pre-heating section 42. The bypasses 41, 43 may be configured to shift a recarbonizing zone within the pre-heating section 42 to minimize processing inefficiencies within pre-heating section 42. For example, the bypasses 41, 43 may help reduce build-up, scaling, or sticking of material within the pre-heating section 42. The inventors further anticipate that in some embodiments (FIG. 26), other pre-heating sections, such as pre-heating section 32 of the second circuit 12, may include one or more bypasses 49 which are configured to feed cooler solids to the pre-heating section 42 of the first circuit 2. One or more of the bypasses 49 depicted in FIG.
26 may be used in combination with one or more of the bypasses 41, 43, 45, 47 shown and described in FIG. 24, 25, 27, or 28, without limitation. For example, in such embodiments, a second gas 14 (such as air) may be utilized in the pre-heating section 32 of the second circuit 12 in an “oxyfurel configuration”. The second gas 14 may be an entraining gas, and may differ from the first entraining gas 4, without limitation.

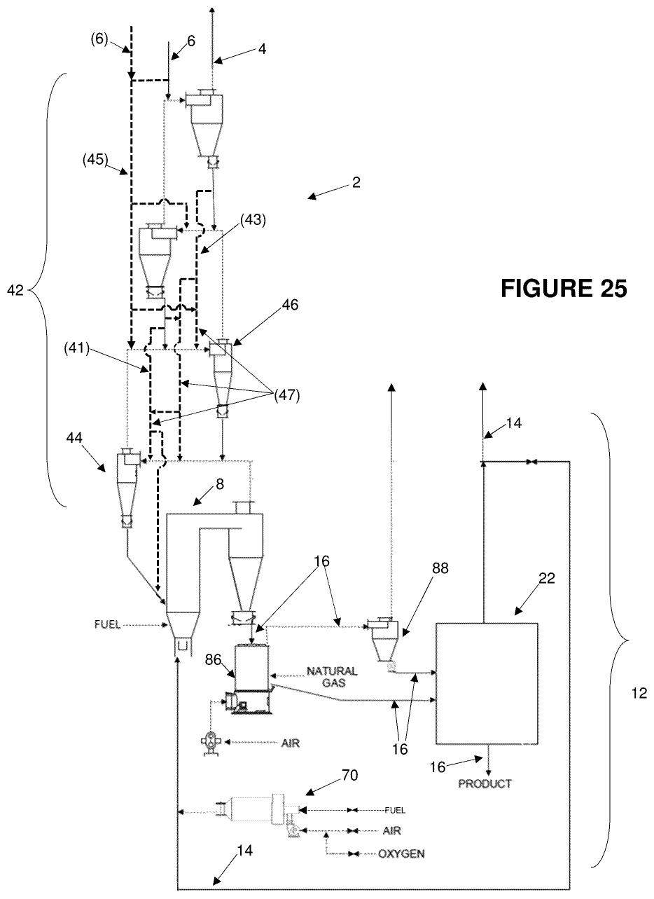

The embodiment of FIG. 25, like the embodiment of FIG. 24, suggests that in any of the previous embodiments depicted in FIGS. 1-23, material in the pre-heating section 42 of the first circuit 2 may be bypassed from one or more upper stages to one or more lower stages whilst skipping at least one (i.e., including skipping “more
than one”) intermediate stage. The embodiment of FIG. 25 differs from that of FIG. 24 in that some carbonated particles 6 entering the pre-heating section 42 may be sent directly to one or more lower stages via a third bypass 45, as shown. For example, in some embodiments, a third bypass 45 may receive carbonated materials 6 from a stream of carbonated materials 6 entering the pre-heating section 42 of the first circuit 2 and/or
the third bypass 45 may receive carbonated materials 6 from its own source of carbonated materials 6, without limitation.

In some embodiments a weighfeeder (not depicted) may be provided upstream of the pre-heating section 42 and utilized to deliver a portion of the carbonated materials 6 entering the pre-heating section 42 to the third bypass 45, and the remaining
carbonated materials 6 to an upper solid/gas suspension heat exchanger within the pre-heating section 42, without limitation. In yet other embodiments, separate feed streams of carbonated materials 6 may be used to independently feed the pre-heating section 42 and the third bypass 45, without limitation. The embodiment depicted in FIG. 25 also differs from that of FIG. 24 in that it suggests that the pre-heating section 42 of the first
circuit 2 may be optionally configured with at least one “combined” bypass 47, wherein any one or more of the first 41, second 43, or third 45 bypasses (if two or more bypasses are employed) may be fluidly connected to each other at one or more junctions or nodes. While not shown, a bypass 41, 43, 45, 47, 49 described herein may be configured to transfer cooler solids from anywhere within in a pre-heating section 32 of a second circuit
12 to a solid/gas suspension heat exchanger within a pre-heating section 42 of a first circuit 2, to change a temperature profile within the pre-heating section 42 of the first circuit 2, without limitation.

Dampers 50 associated with each of the bypasses 41, 43, 45, 47, 49 may
be set for continuous use; or, they may each be periodically or intermittently adjusted, opened, or closed (as necessary) to optimize a temperature profile within the pre-heating section 42 of the first circuit 2 and/or shift a recarbonizing zone within the pre-heating section 42. The dampers 50 may be independently set or adjusted. The dampers 50 may be collectively adjusted simultaneously, or the dampers 50 may be adjusted at different times, without limitation.

Moving carbonated materials 6 from an upper portion of a pre-heating section 32, 42 to a lower portion of said pre-heating section 32, 42 while skipping one or more intermediate pre-heating stages using a bypass 41, 43, 45, 47, 49 may help provide
more flexibility to the reactor 8 in terms of improving the ability of the reactor 8 to manage different fuel types or various mixtures of different types of fuel, without limitation. For example, in the case of changing a fuel type used by the reactor 8, the gas volume (Nm³/t CaO and/or MgO and composition of gas) will likely change, and by consequence, changes in the temperature profile across or within portions of pre-heating section 42
would be expected. By virtue of employing and utilizing one or more of the bypasses 41, 43, 45, 47, 49 described and depicted herein (and by monitoring temperature at select locations within the pre-heating section 42 using temperature sensors 52 and a controller 60), the temperature profile within the pre-heating section 42 may be controlled and stabilized by adjusting/controlling the dampers 50. In other words, a bypass 41, 43, 45, 47, 49 may be configured to help control the pre-heating section 42 temperature profile
as required, when reactor 8 fuels are altered.

It should be understood that the embodiments shown in the Figures are illustrated to be inclusive of the many different conceived arrangements, configurations, and possible permutations of bypasses 41, 43, 45, 47, 49—and that those skilled in the
art will appreciate that in certain embodiments, any one (or more) of the depicted bypasses 41, 43, 45, 47, and (dotted line) portions/segments thereof may be optionally-removed for less complexity within the pre-heating section 42. Thus, the rather complex arrangement depicted in FIG. 25 may be simplified and/or tailored (by way of omission of any dotted line segment(s)) to address specific process needs. Said differently, any
one or more of the bypasses 41, 43, 45, 47, 49 depicted in the figures may be employed in any desired combination or configuration, with any desired alteration from what is shown, without limitation.

It should also be understood that while not expressly depicted in FIG. 25, any one or more of the bypasses 49 shown in FIG. 26 may be used in conjunction with any one or more of the bypasses 41, 43, 45, 47, depicted in FIG. 24 or 25. Accordingly, solids may be configured to move from a first location within a second pre-heating section 32 to a second location within the first pre-heating section 42, to control a temperature profile across or within the first pre-heating section 42.

In some embodiments, the first location of a bypass 41, 43, 45, 47, 49 may comprise one or more feed points introducing fresh carbonated materials (6) to a pre-heating section (42) of the first circuit (2). In some embodiments, the first location of a bypass 41, 43, 45, 47, 49 may comprise a discharge of selective separation means
located within a pre-heating section (42) of the first circuit (2). Each bypass (41, 43, 45, 47, 49) may be configured to bypass at least one selective separation means provided immediately downstream from the first location, as depicted. In some embodiments, a single bypass may be provided (FIG. 28). In some embodiments, a plurality of bypasses may be employed (as shown in FIGS. 24-26), without limitation.

### Some Embodiments

may not include any bypasses (41, 43, 45, 47) in either of first (2) or second (12) circuits; some embodiments may have one or more bypasses (41, 43, 45, 47) in a pre-heating section (42) of a first circuit (2); and some embodiments may have one or more bypasses (41, 43, 45, 47, 49) extending from a pre-heating section (32) of a second circuit (12) to a pre-heating section of the first circuit (2), without limitation

At least one bypass (41, 43, 45, 47, 49) may be present in a pre-heating section (42) of the first circuit (2), and/or present in a pre-heating section (32) of a second circuit (12) as shown. The pre-heating section (42) may be fluidized with a first entraining gas (4) produced from a reactor (8) within the first circuit (2). In some embodiments, a bypass (41, 43, 47, 49) may be configured to deliver a portion of underflow leaving an
upper first solid/gas suspension heat exchanger to an inlet of a third lower third solid/gas suspension heat exchanger, such that a second middle solid/gas suspension heat exchanger (positioned between the first and third solid/gas suspension heat exchanger) is bypassed. In some embodiments, a bypass (41, 43, 47) may be configured to deliver a portion of underflow leaving an upper first solid/gas suspension heat exchanger to an
inlet of a fourth lower third solid/gas suspension heat exchanger, such that second and third middle solid/gas suspension heat exchangers (positioned between the first and fourth solid/gas suspension heat exchanger) are bypassed.

In some embodiments, a bypass (45) may deliver a portion of carbonated
particles (6) entering a pre-heating section (42) of a first circuit (2) to one or more solid/gas suspension heat exchangers below an upper solid/gas suspension heat exchanger in the pre-heating section (42). By providing and using the at least one bypass (41, 43, 45, 47, 49) in the first circuit (2), the amount of recarbonation of CaO and/or MgO particles passing within the first circuit (2) can be prevented, discouraged,
mitigated, reduced, or avoided altogether by virtue of controlling the temperature profile across the pre-heating section (42). This technical advantage clearly differs from that of similar bypasses known in the cement industry (which are traditionally used to increase the temperature of preheater exhaust gas and/or control emission temperature in a combustion chamber).

According to some embodiments, a process for the decarbonation of limestone, dolomite or other carbonated materials, may comprise the step of transferring at least some carbonated materials (6) from i.) a feed point conveying the carbonated materials (6) to the first circuit (2) and/or from ii.) an upper preheater stage
within a number of preheater stages, to one or more lower preheater stages within said number of preheater stages via at least one bypass (41, 43, 45, 47), such that at least one preheater stage therebetween is bypassed. By virtue of this transferring of carbonated materials (6) a temperature profile within or across the pre-heating section (42) of the first circuit (2) can be modified, high temperature zones within the pre-heating section (42) of the first circuit (2) can be moved or reduced, and/or a recarbonation zone
within the pre-heating section (42) of the first circuit (2) can be shifted to a location therein where it has a reduced negative impact to the process (e.g., reduced build-up, scaling, or sticking of material within pre-heating section (42)).

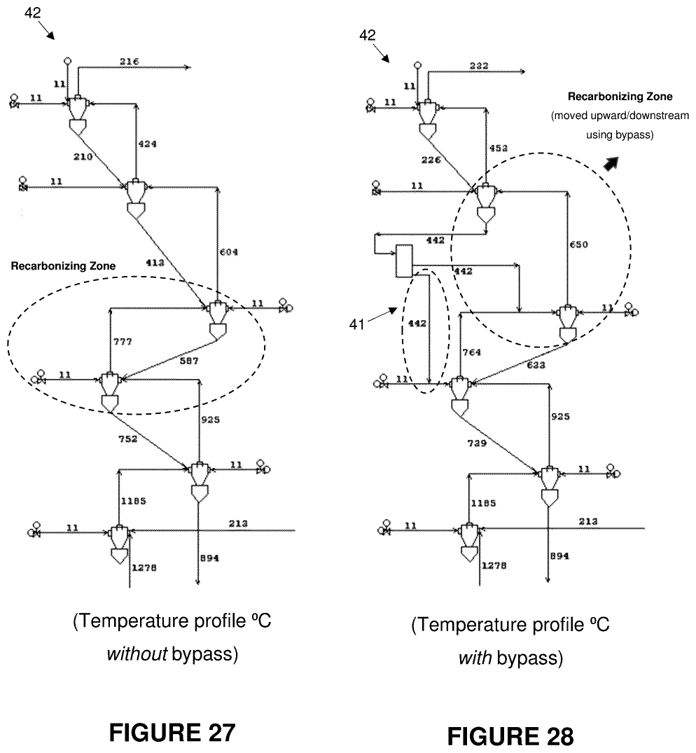

FIGS. 27 and 28 depict how a temperature profile within or across the pre-heating section (42) can be modified, as well as how high temperature zones can be reduced or moved within the pre-heating section (42) using one or more bypasses (41, 43, 45, 47, 49). It can further be gleaned from these two figures how a “recarbonizing zone” may be moved within the pre-heating section (42) using one or more bypasses (41, 43, 45, 47, 49) during operation.

It is envisaged that while not shown, similar results may be alternatively achieved by providing a stream of fresh carbonated materials (6) directly to one or more stages within the pre-heating section (42) (as done with bypass 45 in FIG. 25). It is further envisaged that such fresh carbonated material (6) feed introduction points may
be distributed throughout a pre-heating section (42) in conjunction with one or more bypasses (41, 43, 45, 47, 49) to provide even greater flexibility in: controlling a temperature profile across or within a pre-heating section (42), reducing the formation of high temperature zones within a pre-heating section (42), moving one or more high temperature zones within a pre-heating section (42), or moving a “recarbonizing zone”
further downstream within a pre-heating section (42) in relation to the reactor (8) or source of the first entraining gas (4), without limitation.

In some embodiments, the recarbonizing zone may be relocated to an upper portion of the pre-heating section (42) which is more downstream in relation to the reactor (8). In some embodiments, changing the temperature profile within at least a portion of the pre-heating section (42) using one or more bypasses (41, 43, 45, 47, 49) may be done in such a way that material (e.g., CaO and/or MgO dust from reactor (8)) within the pre-heating section (42) will have a lower tendency to recarbonize or stick to surfaces of apparatus within the pre-heating section (42).

FIG. 27 shows temperatures (in ° C.) of various flow streams within an exemplary pre-heating section (42) of a first circuit (2) devoid of any bypass (41, 43, 45, 47, 49). As depicted, a recarbonizing zone may reside lower within the pre-heating section (42).

FIG. 28 shows temperatures (in ° C.) of various flow streams within a similar pre-heating section (42) of a first circuit (2) which includes at least one bypass (41). It can be readily inferred (through comparison of FIGS. 27 and 28) that a temperature profile within or across the pre-heating section (42) can be changed (i.e., optimized or made more uniform) by employing and/or using at least one bypass (41, 43, 45, 47, 49). Moreover, it can be seen from FIG. 28 that the recarbonizing zone of FIG. 27 can be effectively moved upward within the pre-heating section (42) via the use of at least one bypass (41). In this regard, the recarbonizing zone may be “shifted” or otherwise “re-positioned” to be located higher within the pre-heating section (42), closer to one or more
upper pre-heating stages, and/or further away from and more downstream of reactor (8) or source of the first entraining gas (4).

In the particular non-limiting example shown, the outlet temperature of the third cyclone stage from the top of the pre-heating section (42) is raised from 604 degrees
Celcius to 650 degrees Celcius, thus moving downstream the point in which material flowing through the pre-heating section (42) recarbonizes. It should be noted that in most instances, upper stages within the pre-heating section (42) may expect to see less CaO and/or MgO dust particles coming from reactor (8).

Recarbonizing of decarbonated (16) or partially-decarbonated particles within the first circuit (2) may lead to formation of build-up, scaling, or sticking of material within the pre-heating section (42), which is undesirable. By strategically sacrificing some thermal efficiency (with the introduction of cooler carbonated materials (6) from a first location to a second location having a higher temperature than the first location), the
negative impacts of build-up, scaling, or sticking of material within the pre-heating section (42) can be avoided or at least mitigated. For example, the bypass (41, 43, 45, 47, 49) may discourage material sticking or move “build-up”-prone areas to a location within the pre-heating section (42) which has less overall negative impact to the system and/or process.

Another technical benefit of moving the recarbonizing zone higher/further downstream in the first circuit (2), is that less CaO and/or MgO dust particles coming from the downstream reactor (8) should be able to reach the re-positioned recarbonizing zone. Since the CaO and/or MgO dust particles leaving the reactor (8) would be required
to tortuously pass one or more additional upstream pre-heater stages in order to reach the re-positioned recarbonizing zone (and recarbonize), the likelihood of the CaO and/or MgO dust particles recarbonizing can be reduced, and the amount of recarbonized CaO and/or MgO dust particles entrained within the first circuit (2) can be minimized.

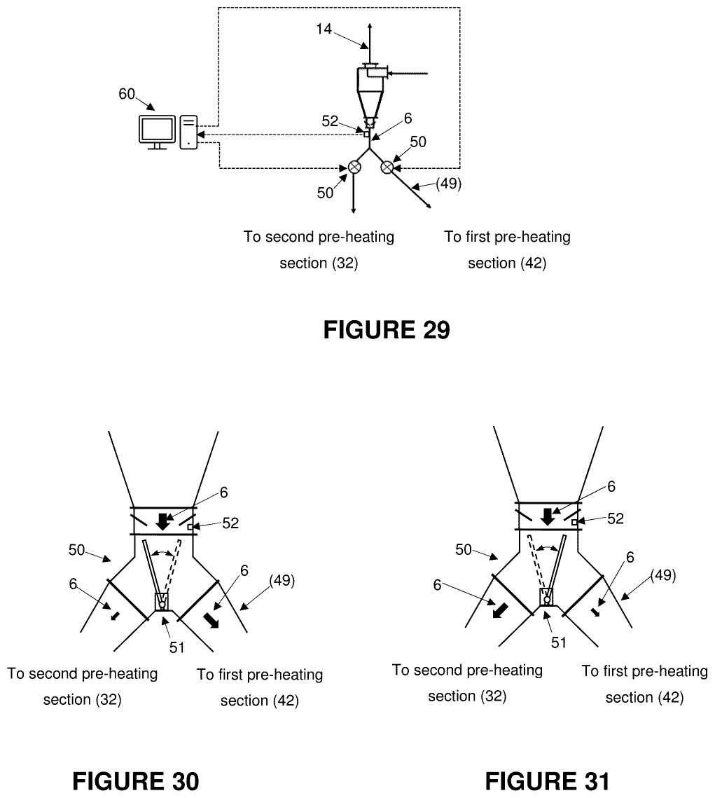

As suggested by schematic FIGS. 29-31, one or more of the bypasses 41, 43, 45, 47, 49 described herein may comprise an associated control damper, valve, or other solids flow control mechanism (hereinafter, “damper” 50) that can be opened, closed, and/or adjusted to permit material to be bypassed at different flow rates. Each damper 50 may be manually controllable (e.g., actuated with a crank, lever, adjustment
screw with worm drive, or the like), but is preferably controlled via automation, using a computer-implemented method of control.

The relative positioning of a flow control mechanism within the bypass damper 50 may be controlled and/or adjusted based on a current temperature
profile within a pre-heating section 32, 42 for example, using a control loop-feedback system. The control loop-feedback system may be implemented through the use of a controller 60, such as a distributed control system (DCS), CPU, local control panel, remote (e.g., cloud-based) web control interface, or other computer control means known in the art.

Temperature sensors 52, such as one or more thermocouples, may be distributed across one or more pre-heating sections 32, 42 of the system and these may periodically deliver real-time localized temperature data to the controller 60 (e.g., in the form of signals such as radio waves (RF), changes in voltage or current, or
the like, without limitation). This temperature data may be received by the controller 60 as inputs to define a current temperature profile across or within the respective pre-heating section 32, 42. The temperature data may be delivered to the controller 60, (having a CPU equipped with a circuit board, processor, and memory-including non-transitory memory such as Computer-Readable Media (CRM) or Random Access Memory (RAM)), without limitation.

The processor may be configured to execute computer code instructions. The computer code instructions may be provided in the form of syntax within software, such as an executable, script, or program. The software may contain therein, a control algorithm which allows the controller 60 to receive temperature data from one or more of
the temperature sensors 52, and at least temporarily store the same in one or more variables using memory. The software may be run to allow the algorithm to produce one or more outputs, based on the received/stored temperature data inputs.

Each of the one or more outputs may comprise a control instruction intended for a mechanical actuator 51 of a bypass 41, 43, 45, 47, 49 damper 50. Each of the one or more outputs may be determined by comparing a particular temperature input from a temperature sensor 52 within a pre-heating section 32, 42, with a predefined temperature threshold value for that particular temperature sensor 52, and assigning a damper control value (e.g., a value which may be true (e.g., “1”) or false (e.g., “0”)),
depending on whether or not the particular temperature input exceeds, falls below, or is equal to the predefined temperature threshold value. For example, in some embodiments, if the damper control value is true, the controller 60 may deliver, per the executable software algorithm, an output control signal to a mechanical actuator 51 of the pertinent damper 50 to open, close, or adjust the damper 50 and control a material
flow therethrough. In doing so, material flows through one or more of the bypasses 41, 43, 45, 47, 49 may be controlled.

An output control signal may include information regarding how much the damper 50 should be adjusted (e.g., open or close), relative to its current flow control
position or flow control mechanism configuration. The processor may continually or periodically process the temperature data inputs using the prescribed control algorithm, and, in response to the algorithm outputs, the controller 60 may continually produce and deliver various control signals to the mechanical actuators 51 of one or more dampers 50 to smartly regulate the temperature profile across the pre-heating section 42 of the
first circuit 42. Controller 60 outputs to mechanical actuators 51 may include voltage changes, current changes, radio (RF) signals, or other signals which, in turn, are received by the mechanical actuator(s) 51 as control inputs. Moreover, the temperature sensor 52 outputs received by the controller 60 may include voltage changes, current changes, radio (RF) signals, or other signals which, in turn, are received by the controller 60 as temperature data.

By “limestone, dolomite or other carbonated materials” is meant (mainly) the carbonated materials fitting the formula:

aCaCO₃·bMgCO₃·cCaMg(CO₃)₂·xCaO·yMgO·zCa(OH)₂·tMg(OH)₂·ul,

wherein:
I are impurities;
x, y, z, t and u each being mass fractions ≥0 and ≤90%,
a, b and c each being mass fractions ≥0 and ≤100%, with a +b+c≥10% by weight, based on the total weight of said materials,
preferably x, y, z, t and u each being mass fractions ≥0 and ≤50%,
a, b and c each being mass fractions ≥0 and ≤100%, with a +b+c≥50% by weight, based on the total weight of said carbonated materials;
the particles of the carbonated minerals having a d90 less than 10 mm, preferably less than 6 mm, more preferably less than 4 mm.

By “decarbonated materials” is meant (mainly) materials fitting the formula:

aCaCO₃·bMgCO₃·cCaMg(CO₃)₂·xCaO·yMgO·zCa(OH)₂·tMg(OH)₂·ul,

wherein:
I are impurities;
a, b, c, z, t and u each being mass fractions ≥0 and ≤50%,
x and y each being mass fractions ≥0 and ≤100%, with x+y≥50% by weight, based on the total weight of said materials.

By “gas composition being substantially free of nitrogen” is meant that the amount of nitrogen represents less than 20% vol., more preferably less than 10% vol., an even more preferably less than 5%, in particular less than 1% in volume (i.e., vol.) of the gas composition.

By “substantially free of carbon dioxide” we understand that the amount of carbon dioxide represents less than 10% vol., more preferably less than 5%, in particular less than 1% in volume (i.e., vol.) of the gas composition.

By “substantially pure oxygen” we understand that the amount of O₂ is greater than 70% vol., more preferably greater than 90% in volume (i.e., vol.) of the gas composition.

By “reactor” we understand that a calciner, a vertical calciner, a flash calciner, a gas suspension calciner (i.e. “GSC”), a non-rotary vertical kiln, a fluidized bed reactor, an entrained bed reactor, a circulated fluidized bed (CFB) reactor, or the like may be practiced, without limitation.

By “recarbonizing zone” we understand that although it is desired for all decarbonated particles (16) to move downstream from reactor (8) to a second circuit (12), some decarbonated particles (16) or partially-decarbonated particles may re-enter the pre-heating section (42) of the first circuit (2) and come in contact with carbon dioxide
by way of the first entraining gas (4), and thus, “re-carbonize”. The region within the first circuit (2) (and more particularly, the region within the pre-heating section (42) of the first circuit (2)) in which short-circuiting decarbonated (16) or partially-decarbonated particles “re-carbonize” would constitute a recarbonizing zone.

The inventors envisage that the occurrence of recarbonation, the
formation of recarbonizing zones, and prevalence of recarbonizing zones which are located lower in the pre-heating section (42) may be expected to be more common in a first circuit (2) due to higher CO₂ concentrations in the first entraining gas (4) leaving reactor (8). For example, in some instances, where CO₂ concentrations of the first entraining gas (4) exceed approximately 50 vol %, and more preferably above 85 vol % (dry).

By “selective separation means” we understand that a solid/gas separator (88), such as one or more cyclone separators or solid/gas suspension heat exchangers (34, 46, 47) may be used.

Where used herein and in the claims, the term “device” may be used interchangeably with the term “system”. By “system” we understand that a “device”, during its operation, may physically comprise, contain, or circulate therein certain gasses (e.g., 4, 14, 14′) which are unique to, specific to, or important for performing a process for the decarbonation of limestone, dolomite or other carbonated materials. Thus, the term “system” refers to a “device” which physically comprises the recited gases (e.g., during operation of the “device”).

Although the present invention has been described and illustrated in detail, it is understood that the same is by way of illustration and example only and is not to be taken by way of limitation, the scope of the present invention being limited only by the terms of the appended claims.

1. Process for the decarbonation of limestone, dolomite or other carbonated materials, said process comprising the following steps:
heating particles of carbonated materials (6) in a reactor (8) of a first circuit (2) up to a temperature range in which carbon dioxide of the carbonated materials is released to obtain decarbonated particles (16) comprising CaO and/or MgO;
conveying particles of carbonated materials (6) by a first entraining gas (4) in the first circuit (2) for preheating said carbonated materials (6);
transferring the decarbonated particles (16) to a cooling section (22) of a second circuit (12) in which the conveyed decarbonated particles (16) release a portion of their thermal energy to a second entraining gas (14);
providing substantially pure oxygen to the reactor (8) at an oxygen entrance point; the oxygen entrance point being located at a first location of the reactor (8);
providing fuel to the reactor (8) at a plurality of fuel entrance points;
each of the plurality of fuel entrance points being sequentially-spaced from one another along the reactor (8) and which are each located above the first location of the reactor (8);
independently adjusting and/or controlling the flow of fuel to each of the fuel entrance points;
combusting the fuel and oxygen within the reactor (8); and
by virtue of independently adjusting and/or controlling the flow of fuel to each of the fuel entrance points, controlling the temperature gradient of process
gas throughout the reactor (8) to minimize high temperature zones and maintain a maximum temperature difference of the process gas distributed throughout the reactor (8) to less than 200° C.

2. Process according to claim 1, further comprising the steps of:
introducing substantially pure oxygen to a hot gas generator and directing heated substantially pure oxygen from the hot gas generator (70) to the reactor (8) at the oxygen entrance point; and
optionally using the hot gas generator (70) as a “start-up heater” by temporarily introducing air to the hot gas generator and supplying heated air to the reactor (8) from the hot gas generator during initial commissioning of the reactor (8).

3. Process according to claim 1, further comprising the steps of:
separating the decarbonated particles (16) from a second entraining gas (14) flow in the cooling section (22);
wherein said second entraining gas (14) is comprised of substantially pure oxygen.

4. Process according to claim 1, further comprising the step of:
delivering at least some of the first entraining gas (4) to the reactor (8) in order to control and/or maintain a velocity of the flow of gases provided to the
reactor (8) within a predetermined velocity range.

5. Process for the decarbonation of limestone, dolomite or other carbonated materials, said process comprising the following steps:
heating particles of carbonated materials (6) in a reactor (8) of a first circuit (2) up to a temperature range in which carbon dioxide of the carbonated materials is released to obtain decarbonated particles (16) comprising CaO and/or MgO;
conveying particles of carbonated materials (6) by a first entraining gas (4) in the first circuit (2) for preheating said carbonated materials (6);
transferring the decarbonated particles (16) to a cooling section (22) of a second circuit (12) in which the conveyed decarbonated particles (16) release a portion of their thermal energy to a second entraining gas (14);
separating the carbonated particles (6) from a first entraining gas (4) flow;
transferring the decarbonated particles (16) to a cooling section (22) of a second circuit (12) comprising a second entraining gas (14) in which the
conveyed decarbonated particles (16) release a portion of their thermal energy;
providing substantially pure oxygen to the reactor (8); and
delivering at least some of the first entraining gas (4) to the reactor (8) in order to control and/or maintain a velocity of the substantially pure oxygen provided to the reactor (8) within a predetermined velocity range.

6. Process according to claim 5, wherein said step of heating particles of carbonated materials (6) in a reactor (8) of a first circuit (2) comprises introducing oxygen to a hot gas generator and directing heated oxygen from the hot gas generator to the reactor (8); and
optionally using the hot gas generator as a “start-up heater” by introducing air to the hot gas generator and supplying heated air to the reactor (8) from the hot gas generator during initial commissioning of the reactor (8).

7. Process for the decarbonation of limestone, dolomite or other carbonated materials, said process comprising the following steps:
heating particles of carbonated materials (6) in a reactor (8) of a first circuit (2) up to a temperature range in which carbon dioxide of the carbonated materials is released to obtain decarbonated particles (16) comprising CaO and/or MgO;
conveying particles of carbonated materials (6) by a first entraining gas (4) in the first circuit (2) for preheating said carbonated materials (6);
transferring the decarbonated particles (16) from the first circuit (2) to a cooling section (22) of a second circuit (12) in which a second entraining gas (14) circulates;
cooling the decarbonated particles (16) in the cooling section (22) of the second circuit (12);
heating the second entraining gas (14) by virtue of the decarbonated particles (16) releasing a portion of their thermal energy to the second entraining gas (14);
separating the decarbonated particles (16) from a second entraining gas (14) flow;
transferring the decarbonated particles (16) from the second circuit (12) to a cooling section (22′) of a third circuit (12′) in which a third entraining gas (14′) circulates;
cooling the decarbonated particles (16) in the cooling section (22′) of the third circuit (12′);
heating the third entraining gas (14′) by virtue of the decarbonated particles (16) releasing a portion of their thermal energy to the third entraining gas (14′);
separating the decarbonated particles (16) from a third entraining gas (14′) flow;
delivering at least some of the heated second entraining gas (12) from the cooling section (22) of the second circuit (12) to the reactor (8), the second entraining gas being substantially pure oxygen.
delivering at least some of the heated third entraining gas (14′) from the cooling section (22′) of the third circuit (12′) to a heating section (32′) of the third circuit
(12′) which is downstream of the cooling section (22′) of the third circuit (12′).

8. Process for the decarbonation of limestone, dolomite or other carbonated materials, said process comprising the following steps:
heating particles of carbonated materials (6) in a reactor (8) of a first circuit (2) up to a temperature range in which carbon dioxide of the carbonated materials is released to obtain decarbonated particles (16) comprising CaO and/or MgO;
conveying particles of carbonated materials (6) by a first entraining gas (4) in the first circuit (2) for preheating said carbonated materials (6);
transferring the decarbonated particles (16) from the first circuit (2) to a cooling section (22) of a second circuit (12) in which a second entraining gas (14) circulates;
cooling the decarbonated particles (16) in the cooling section (22) of the second circuit (12);
heating the second entraining gas (14) by virtue of the decarbonated particles (16) releasing a portion of their thermal energy to the second entraining gas (14);
separating the decarbonated particles (16) from a second entraining gas (14) flow;
transferring the decarbonated particles (16) from the second circuit (12) to a cooling section (22′) of a third circuit (12′) in which a third entraining gas (14′) circulates;
cooling the decarbonated particles (16) in the cooling section (22′) of the third circuit (12′);
heating the third entraining gas (14′) by virtue of the decarbonated particles (16) releasing a portion of their thermal energy to the third entraining gas (14′);
separating the decarbonated particles (16) from a third entraining gas (14′) flow;
delivering at least some of the heated second entraining gas (12) from the cooling section (22) of the second circuit (12) to a heating section (32) of the second circuit (12) which is downstream of the cooling section (22) of the second circuit (12);
delivering at least some of the heated third entraining gas (14′) from the cooling section (22′) of the third circuit (12′) to the reactor (8), the third entraining gas (14′) being substantially pure oxygen.

9. Process according to any one of the preceding claims, further comprising the steps of:
introducing the particles of carbonated materials (6) to a pre-heating section (42) of the first circuit (2) so that said particles are pre-heated by the first entraining gas (4) by means of solid-gas heat exchange; said pre-heating section
(42) comprising at least a first solid/gas suspension heat exchanger (44), a filter,
and at least one fan being located downstream of the at least a first solid/gas suspension heat exchanger (44) and upstream and/or downstream of the filter; wherein the first solid/gas suspension heat exchanger (44) comprises an inlet (44.1), an outlet (44.2), and a return (44.3); and
reducing ambient air ingress into the pre-heating section (42) of the first circuit (2) by virtue of performing at least one of the following steps:
I. maintaining a pressure drop between the inlet (44.1) and the outlet (44.2) which is equal to or below 1 KPa;
II. maintaining an operating pressure in the pre-heating section (42) which is above a pressure of the ambient air by increasing the pressure of the substantially pure oxygen entering the reactor (8);
III. maintaining an operating pressure in the reactor section (8) which is above a pressure of the ambient air by increasing the pressure of substantially pure oxygen entering the reactor (8);
IV. adjusting an RPM speed and/or louver/damper setting of the at least one of the fan to maintain a pressure in the filter that is above ambient pressure;
V. adjusting an RPM speed and/or a louver/damper setting of the first fan, such that an operating pressure in the reactor (8) is maintained between
−1 kPa and +1 kPa.

10. Process according to any one of the preceding claims, further comprising the steps of:
producing the first entraining gas (4) using the reactor (8);
conveying the decarbonated particles (16) to a second reactor (86) which is positioned downstream of the reactor (8) and upstream of a cooling section (22) of a second circuit (12);
conveying the decarbonated particles (16) from the second reactor (86) to the cooling section (22) of the second circuit (12) in which the conveyed decarbonated particles (16) release a portion of their thermal energy;
maintaining a reductive environment within the second reactor (86) by virtue of at least partially combusting carbon-containing fuel in the second reactor (86); and
venting gas from the second reactor (86) in one of the following manners:
I. venting gas from the second reactor (86) to a solid/gas separator located downstream of the second reactor (86) and upstream of the cooling section (22) of the second circuit (12);
II. venting gas from the second reactor (86) separately from the first entraining gas (4) so as to avoid mixing between the first entraining gas (4) and the vented gas from the second reactor (86);
III. venting gas from the second reactor (86) to a solid/gas suspension exchanger (34) provided within a heating section (32) of the second circuit (12); the heating section (32) being located downstream of the cooling section (22) of the second circuit (12);
IV. venting gas from the second reactor (86) and recycling at least some of the vented gas from the second reactor (86) back to the second reactor (86).

11. Process according to any one of the preceding claims, further comprising the steps of:
conveying the decarbonated particles (16) to a second reactor (86) which is positioned downstream of the reactor (8) and upstream of the cooling section (22) of the second circuit (12);
conveying the decarbonated particles (16) from the second reactor (86) to the cooling section (22) of the second circuit (12);
introducing a gas substantially free of CO₂, such as steam, to the second reactor (86); and
venting gas from the second reactor (86) to the reactor (8).

12. Process according to any one of the preceding claims, further comprising the steps of:
conveying particles of carbonated materials (6) by a first entraining gas (4) in a plurality of primary pre-heating sections (42) of the first circuit (2) for preheating said carbonated materials (6);
conveying the particles of carbonated materials (6) to one or more reactors (8) downstream of the plurality of primary pre-heating sections (42); and
transferring the decarbonated particles (16) from the one or more reactors (8) to one or more cooling sections (22) in the second circuit (12) and/or to one or more second reactors (86) located downstream of the one or more reactors (8).

13. Process according to any one of the preceding claims, further comprising the steps of:
introducing fuel and/or oxygen through a indirect heat exchanger (61,62) within the cooling section (22) of a second circuit (12);
cooling the decarbonated particles (16) in the cooling section (22) of the second circuit (12);
heating the fuel and/or oxygen using the indirect heat exchanger (61, 62) by virtue of:
I. heat transfer between the decarbonated particles (16) and the fuel and/or oxygen introduced to the indirect heat exchanger (62); and/or
II. heat transfer between the second entraining gas (14) and the fuel and/or oxygen introduced to the indirect heat exchanger (61); and
delivering heated fuel and/or oxygen to the reactor (8) from the indirect heat exchanger (61, 62).

14. Process according to any one of the preceding claims, further comprising the steps of:
heating the second entraining gas (14) by virtue of the conveyed decarbonated particles (16) releasing a portion of their thermal energy;
supplementally heating the second entraining gas (14) downstream of the cooling section (22) of the second circuit (12);
conveying supplementally-heated second entraining gas (14) to a heating section (32) of the second circuit (12) which is positioned downstream of said cooling section (22) and upstream of the reactor (8) in order to reduce oxygen consumption of the reactor (8);
heating particles of carbonated materials (6) in the heating section (32) of the second circuit (12) using the supplementally-heated second entraining gas (14); and
delivering heated particles of carbonated materials (6) from the heating section (32) of the second circuit (12) to the reactor (8).

15. Process according to any one of the preceding claims, further comprising the steps of:
combusting fuel and oxygen within the reactor (8); and
performing at least one of the following steps:
I. adjusting, controlling, and/or changing a composition of the fuel during the step of combusting fuel and oxygen within the reactor (8);
II. supplying a first type of fuel to a first one of a plurality of different fuel entrance points along the reactor (8) and supplying a second type of fuel to
a second one of said plurality of different fuel entrance points along the reactor (8);
III. supplying a first type of fuel to the reactor (8), and subsequently supplying a second type of fuel to the reactor (8); the second type of fuel being different in composition than the first type of fuel;
wherein the fuel is selected from one or more of the group consisting of: hydrogen gas; a solid fuel; and a fossil fuel.

16. Process according to any one of the preceding claims, further comprising the steps of:
combusting solid fuel and oxygen within the reactor (8) to produce a first entraining gas (4); and
using either at least a portion of the first entraining gas (4) or a gas substantially free of nitrogen, to pneumatically convey the solid fuel to: i.) the reactor (8) and/or ii.) a hot gas generator configured to heat said substantially pure oxygen provided to the reactor (8);
wherein the solid fuel comprises comprise particulate material including, but not limited to, plastics, coal, and/or biomass.

17. Process according to any one of the preceding claims, wherein said first entraining gas (4) comprises carbon dioxide released from the carbonated materials (6), and is substantially free of nitrogen.

18. Process according to claim 1, 5, 7 or 8, further comprising cooling the particles of decarbonated materials (16) with a second entraining gas (14) in the cooling section (22) of the second circuit (12); wherein the second entraining gas (14) is substantially free of carbon dioxide.

19. Process according to claim 2 or 6, wherein said substantially pure oxygen is delivered to the reactor (8) in combination with at least some of the second entraining gas (14) entering the reactor (8).

20. Process according to claim 10, wherein said carbon-containing fuel comprises a fuel selected from the group consisting of: natural gas, propane, methane, or a solid fuel such as lignite or bituminous coal.

21. Device for the decarbonation of limestone, dolomite or other carbonated materials comprising:
a first circuit (2) in which a first entraining gas (4) substantially free of nitrogen conveys particles (6) of a carbonated mineral, said first circuit comprising a reactor (8) in which said particles (6) are heated to a temperature range in which carbon dioxide is released to obtain decarbonated particles (16) comprising CaO and/or MgO;
a second circuit (12) in which a second entraining gas (14) substantially free of carbon dioxide is circulated, the second circuit (12) comprising a cooling section (22) in which the decarbonated particles (16) transferred from the first circuit (2), release a portion of their thermal energy to the second entraining gas (14);
a source of substantially pure oxygen, the reactor (8) being supplied with said source of substantially pure oxygen;
a source of fuel, the reactor (8) being supplied with said source of fuel;
wherein the reactor (8) has an oxygen entrance point being located at a first location of the reactor (8) and a plurality of fuel entrance points; each of the plurality of fuel entrance points being sequentially-spaced from one another along the reactor (8)
and which are each located above the first location of the reactor (8).

22. Device for the decarbonation of limestone, dolomite or other carbonated materials comprising:
a first circuit (2) in which a first entraining gas (4) substantially free of nitrogen conveys particles (6) of a carbonated mineral, said first circuit 35 comprising a reactor (8) in which said particles (6) are heated to a temperature range in which carbon dioxide is released to obtain decarbonated particles (16) comprising CaO and/or MgO;
a second circuit (12) in which a second entraining gas (14) substantially free of carbon dioxide is circulated, the second circuit (12) comprising a cooling section (22) in which the decarbonated particles (16) transferred from the first circuit (2), release a portion of their thermal energy to the second entraining gas (14); and
a third circuit (12′) in which a third entraining gas (14′) substantially free of carbon dioxide is circulated, the third circuit (12′) comprising a cooling section (22′) in which the decarbonated particles (16) transferred from the second circuit (12), release a portion of their thermal energy to the third entraining gas (14′).

23. Device according to claim 22, wherein the third circuit (12′) comprises a heating section (32′) positioned downstream from the cooling section (22′) of the third circuit (12′), the second entraining gas (14) is substantially pure oxygen and the
reactor (8) comprises an oxygen entrance point arranged downstream from the second circuit (12).

24. Device according to claim 22, wherein the second circuit (12) comprises a heating section (32) positioned downstream from the cooling section (22) of the
second circuit (12), the third entraining gas (14′) is substantially pure oxygen and the reactor (8) comprises an oxygen entrance point arranged downstream from the third circuit (12′).

25. Device according to claim 23 or 24, wherein the cooling section (22,22′) and heating section (32, 32′) each comprising at least one solid/gas suspension heat exchanger (24, 24′, 34, 34′).

26. Device according to any of claims 22 to 25, wherein the first circuit (2) comprises a pre-heating section (42), said pre-heating section (42) comprising at least a first solid/gas suspension heat exchanger (44) and/or a second solid/gas suspension exchanger (46), preferably said second solid/gas suspension exchanger (46) being positioned downstream from said first solid/gas suspension heat exchanger (44).

27. Device for the decarbonation of limestone, dolomite or other carbonated materials comprising:
a first circuit (2) in which a first entraining gas (4) conveys carbonated materials (6), the first circuit (2) comprising a reactor (8) in which said carbonated materials (6) are heated to a temperature range in which carbon dioxide is released to obtain decarbonated materials (16) comprising CaO and/or MgO;
a second circuit (12) in which a second gas (14) is circulated, the second circuit (12) comprising a cooling section (22) in which the decarbonated materials
(16) transferred from the first circuit (2), release a portion of their thermal energy to the second gas (14);
a bypass (41, 43, 45, 47, 49) extending between a first location and a second location, the bypass (41, 43, 45, 47, 49) being configured for conveying carbonated materials (6) from the first location to the second location;
wherein the first location is proximate to one of: i) a feed of carbonated materials (6) to a pre-heating section (42) of the first circuit (2), ii) a lower discharge of a solid/gas suspension exchanger within a pre-heating section (42) of the first
circuit (2), iii) a lower discharge of a solid/gas suspension exchanger within a pre-heating section (32) of the second circuit (12);
wherein the second location is more proximate to the reactor (8) and/or to the source of the first entraining gas (4) than the first location and comprises a higher temperature than the first location;
wherein the bypass (41, 43, 45, 47, 49) is configured to allow carbonated materials (6) to bypass or circumvent at least one intermediate solid/gas suspension exchanger in the pre-heating section (42) of the first circuit (2);
wherein the bypass (41, 43, 45, 47, 49) is configured to minimize recarbonizing of decarbonated materials (16) exhausted from the reactor (8) and/or
residing within the pre-heating section (42) of the first circuit (2); and
wherein the bypass (41, 43, 45, 47, 49) is configured to allow a temperature profile within at least a portion of the pre-heating section (42) to be controlled and/or modified by virtue of the first entraining gas (4) releasing a portion of its thermal energy to the carbonated materials (6) being transferred to the second
location from the first location via the bypass (41, 43, 45, 47, 49).

28. Device according to claim 27, further comprising a plurality of said bypass (41, 43, 45, 47, 49).

29. Device according to claim 28, wherein each of the plurality of said bypass (41, 43, 45, 47, 49) extend from a different first location.

30. Device according to claim 28 or 29, wherein each of the plurality of said bypass (41, 43, 45, 47, 49) extend to a different second location.

31. Device according to claim 28 or 29, wherein at least two of the plurality of said bypass (41, 43, 45, 47, 49) extend to the same second location.

32. Device according to any one of claims 28-31, wherein at least two of the plurality of said bypass (41, 43, 45, 47, 49) fluidly communicate and/or intersect at a junction or node to form a combined bypass (45).

33. Device according to any one of claims 27-32, wherein the second location is located at, proximate to, or upstream of an inlet (44.1, 46.1) to a lower solid/gas suspension exchanger (44, 46) provided within the pre-heating section (42) of the first circuit (2).

34. Device according to any one of claims 27-33, wherein the at least one intermediate solid/gas suspension exchanger is provided above a lower solid/gas suspension exchanger (44, 46) within the pre-heating section (42) of the first circuit (2).

35. Device according to any one of claims 27-34, wherein the carbonated materials (6) conveyed from the first location have a lower temperature than carbonated materials
(6) or the first entraining gas (4) upstream the second location.

36. Device according to any one of the claims 27-35, wherein the second gas (14) is an entraining gas.

37. Process for the decarbonation of limestone, dolomite or other carbonated materials, said process comprising the following steps:
heating carbonated materials (6) in a reactor (8) of a first circuit (2) up to a temperature range in which carbon dioxide of the carbonated materials is released to obtain decarbonated materials (16) comprising CaO and/or MgO;
conveying carbonated materials (6) by a first entraining gas (4) in the first circuit (2) for preheating said carbonated materials (6) within a pre-heating section (42) of the first circuit (2);
conveying carbonated materials (6) from a lower temperature first location to a higher temperature second location within the pre-heating section (42) of the first circuit (2) using a bypass (41, 43, 45, 47, 49); wherein the second location is provided more proximate to the reactor (8) and/or to a source of the
first entraining gas (4) than the first location;
allowing the conveyed carbonated materials (6) to bypass or circumvent at least one intermediate solid/gas suspension exchanger within the pre-heating section (42) of the first circuit (2);
transferring heat from the first entraining gas (4) to carbonated materials (6) conveyed to the second location from the first location;
modifying and/or controlling a temperature profile within at least a portion of the pre-heating section (42) of the first circuit (2); and
by virtue of modifying and/or controlling a temperature profile within at least a portion of the pre-heating section (42) of the first circuit (2), minimizing recarbonizing of decarbonated or partially-decarbonated materials exhausted from the reactor (8) and/or residing within the pre-heating section (42) of the first circuit (2).

38. Process according to claim 37, further comprising the step of repositioning a recarbonizing zone within the pre-heating section (42) to a location more downstream of the reactor (8), to a location further away from the reactor (8), to a location higher in the pre-heating section (42), and/or to a location within the pre-heating section (42) which reduces or minimizes build-up, scaling, or sticking of material within the pre-heating section (42) caused by recarbonizing of said de-carbonated or partially-decarbonated materials.

39. Process according to claim 37 or 38, further comprising the step of minimizing the formation of one or more high temperature zones within the pre-heating section (42) of the first circuit (2), reducing one or more high temperature zones within the pre-heating section (42) of the first circuit (2), and/or moving a high temperature zone within the pre-heating section (42) of the first circuit (2).

40. Process according to any one of claims 36-38, further comprising the step of selectively cooling a feed to one or more solid/gas suspension exchangers (44, 46) provided within the pre-heating section (42) of the first circuit (2) and below the at least one intermediate solid/gas suspension exchanger, with carbonated materials (6) conveyed by the bypass (41, 43, 45, 47, 49).

41. Process according to any one of the claims 37-40, wherein the second gas (14) is an entraining gas.

42. System for the decarbonation of limestone, dolomite or other carbonated materials comprising:
a first circuit (2) configured for heating carbonated particles (6); the first circuit (2) comprising:
i.) a preheating section (42) configured to convey the carbonated particles (6) to a reactor (8), the preheating section (42) comprising at least one solid/gas suspension heat exchanger (44, 46) and a first entraining gas (4) substantially free of nitrogen circulating within the preheating section (42) and configured to heat the carbonated particles (6) in the preheating section (42); and
ii.) a reactor (8) configured to heat said carbonated particles (6) to a temperature range in which carbon dioxide of the carbonated particles (6) is released to obtain decarbonated particles (16) comprising CaO and/or
MgO; the reactor (8) producing the first entraining gas (4) by combusting fuel and substantially pure oxygen therein; the reactor (8) comprising an oxygen entrance point being located at a first location of the reactor (8) and a plurality of fuel entrance points separated from the oxygen entrance point;
a second circuit (12) downstream of the reactor (8) of the first circuit (2) and configured to receive decarbonated particles (16) from the first circuit (2) and being configured to cool the decarbonated particles (16), the second circuit (12) comprising:
i.) a cooling section (22) configured to cool the decarbonated particles (16) received from the first circuit (2); the cooling section (22) comprising a second entraining gas (14) substantially free of carbon dioxide circulating within the cooling section (22) and configured to cool the decarbonated particles (16) in the cooling section (22); and
ii.) means for delivering the second entraining gas (14) to the cooling section (22) of the second circuit (12);
a source of substantially pure oxygen;
means for delivering substantially pure oxygen from the source of substantially pure oxygen to the oxygen entrance point of the reactor (8);
at least one source of fuel; and
means for delivering fuel from the at least one source of fuel to each of the plurality of fuel entrance points of the reactor (8);
wherein each of the plurality of fuel entrance points are configured to be independently adjustable and/or controllable to vary or restrict a flow of fuel therethrough; each of the plurality of fuel entrance points being spaced from one another along the reactor (8); each of the plurality of fuel entrance points being located above the first location of the oxygen entrance point to the reactor (8);
the reactor (8) comprising a temperature gradient of process gas throughout the reactor (8); said temperature gradient of process gas having a minimum temperature and a maximum temperature;
wherein the oxygen entrance point is configured to receive substantially pure oxygen from the source of substantially pure oxygen;
wherein each of the plurality of fuel entrance points are configured to receive fuel from the at least one source of fuel; and
wherein the plurality of fuel entrance points are each independently set, adjusted, or configured such that resulting flow paths of fuel to the reactor (8) are restricted to a configuration that limits a maximum temperature difference of process gas distributed throughout the reactor (8) to less than 200° C. and/or such that the difference between said minimum temperature and maximum temperature within the temperature gradient of process gas throughout the reactor (8) is less than 200° C.

43. System for the decarbonation of limestone, dolomite or other carbonated materials comprising:
a first circuit (2) comprising: a first entraining gas (4) substantially free of nitrogen, particles (6) of a carbonated mineral, and a reactor (8) configured to
produce decarbonated particles (16) comprising CaO and/or MgO from the particles (6) of a carbonated mineral by heating the particles (6) of a carbonated mineral to release carbon dioxide therefrom; the reactor (8) being configured to produce the first entraining gas (4) by combusting fuel and substantially pure oxygen therein;
a second circuit (12) downstream of the first circuit (2) comprising: a second entraining gas (14) substantially free of carbon dioxide, a cooling section (22) configured to cool decarbonated particles (16) produced in and leaving the first circuit (2), a source of first cooling gas, the first cooling gas being configured to produce the second entraining gas (14), and means for delivering the first cooling gas to the cooling section (22) of the second circuit (12); the second entraining gas
(14) being configured to receive a portion of thermal energy from the decarbonated particles (16) produced in and leaving the first circuit (2) to pre-cool the decarbonated particles (16) produced in and leaving the first circuit (2); and
a third circuit (12′) downstream of the second circuit (12) comprising: a third entraining gas (14′) substantially free of carbon dioxide and which comprises a different composition than the first (2) and second (14) entraining gases, a cooling
section (22′) configured to supplementally cool pre-cooled decarbonated particles (16) leaving the second circuit (12), a source of second cooling gas, the second cooling gas being configured to produce the third entraining gas (14′), and means for delivering the second cooling gas to the cooling section (22′) of the third circuit (12′); the third entraining gas (14) being configured to receive a portion of thermal
energy from the pre-cooled decarbonated particles (16) produced in and leaving the second circuit (12) to supplementally cool the pre-cooled decarbonated particles (16) produced in and leaving the second circuit (12).

44. System according to claim 43, wherein the second cooling gas comprises air, the first cooling gas comprises substantially pure oxygen, and the processing system further comprises:
a. means for delivering the third entraining gas (14′) to a heating section (32′) of the third circuit (12′), and
b. means for delivering the second entraining gas (14) to the reactor (8) of the first circuit.

45. System according to claim 43, wherein the second cooling gas comprises substantially pure oxygen, the first cooling gas comprises air, and the processing system further comprises:
a. means for delivering the third entraining gas (14′) to the reactor (8) of the first circuit (2), and
b. means for delivering the second entraining gas (14) to a heating section (32) of the second circuit (2).

46. Apparatus configured to perform the process defined in any one of claim 1-20 or 37-41.

47. Apparatus substantially as shown and described with reference to any one of FIGS. 1-31.
